(19) United States
(12) Patent Application Publication
(10) Pub. No.: US 2014/0168961 A1
(43) Pub. Date: Jun. 19, 2014

(54) RETROFIT KIT FOR FLUORESCENT LAMP FIXTURES

(71) Applicant: JACK GUY DUBORD, Escondido, CA (US)

(72) Inventor: JACK GUY DUBORD, Escondido, CA (US)

(21) Appl. No.: 13/718,768

(22) Filed: Dec. 18, 2012

(51) Int. Cl. F21V 21/005; F21V 11/00; F21V 21/00; F21S 4/00; F21V 21/14

(52) U.S. Cl. CPC F21V 21/005; F21S 4/001; F21V 21/00; F21V 11/00
USPC 362/225; 362/217.16; 362/217.01; 362/249.01; 362/217.02

(57) ABSTRACT

A retrofit kit for a gutted fluorescent light fixture includes a self contained source of visible radiant energy configured to replicate a light pattern generated by the gutted fluorescent light fixture but with improved luminance; where the self contained source of visible radiant energy is adapted to be coupled to a universal source of electrical energy and supported by the fluorescent light fixture without modification after the fluorescent light fixture has been gutted of its ballast, electrical sockets, fluorescent bulb and ballast cover.

### CROSS-REFERENCE TO PRIOR APPLICATION

This application claims priority to U.S. Provisional Patent Application Ser. No. 61/580,222 Entitled, “Retrofit Kit for Improving Luminance Output from Lighting System and Method of Assembling and Testing a Retrofit Kit”, by Jack Dubord, filed on Dec. 24, 2011. This application is also a continuation-in-part of U.S. Utility patent application Entitled “Adjustable Light Emitting Diode Lighting Assembly, kit and System and Method of Assembling an Adjustable Light Emitting Diode Lighting Assembly,” by Jack Dubord, U.S. patent Ser. No. 13/151,158, filed Jun. 1, 2011, as a Continuation-in-Part of U.S. patent Ser. No. 12/261,754, filed on Oct. 30, 2008, and a Continuation-in-Part of U.S. patent Ser. No. 12/386,545, filed on Apr. 20, 2009, which application claims the benefit of U.S. Provisional Patent No. 61/057,858, filed on Jun. 1, 2008 each one of such referenced patent applications being incorporated herein as though fully set forth.

### FIELD OF THE INVENTION

This invention generally relates to lighting systems and apparatus and methods and more particularly relates to a retrofit kit for improving the luminance output of a lighting system and method of assembling and testing a retrofit kit.

### BACKGROUND OF THE INVENTION

Standard ceiling mounted fluorescent lighting systems provide 360 degrees of light where 50% of the light output is reflected. So for example a 1500 lumens fluorescent bulb when mounted in a ceiling lighting fixture will provide about 700 lumens of light output since the bulb is configured for 360 degree illumination resulting in at least 50% of the light output of the bulb being directed toward the rear of its fixture where it must then be reflected to provide a luminance output. In short then, a fluorescent bulb with a 1500 lumen rating will only produce 750 lumens due to this inefficiency. Therefore it would be highly desirable to have a new and improved retrofit kit for such a fluorescent lighting system that not only consumes less power, but also substantially increases the light output of the lighting system.

There have been many different types and kinds retrofit kits and methods for retrofitting light fixtures. For example, reference may be made to the following U.S. Pat. Nos. 8,256,938; 8,240,273; 8,235,555; 8,100,552; 8,025,423; 7,845,832; 7,677,766; 7,507,001; 6,853,151; and U.S. Pat. No. 5,388,357. While such retrofit kits may have been generally satisfactory, there is nevertheless a need for a new and retrofit kit and method of retrofitting a lighting fixture with a single elongated lamp to a light fixture with a plurality of light sources having improved luminance.

### SUMMARY OF THE INVENTION

The present invention addresses the shortcomings of the prior art as mentioned hereinabove by providing a retrofit kit for improving the luminance output of a lighting system and method of assembling a retrofit kit into a conventional fluorescent lighting fixture. The retrofit kit and new and improved lighting system generally comprises mounting means, such as mounting brackets, or screws, a mounting plate or troffer insert having mounted thereto a printed circuit board configured with clusters of light emitting diodes (LEDs) that are coupled to an associated power source also mounted to the mounting plate for supplying the LEDs with a source of electrical power. The power source is pre-connected to the LEDs and is provided with a male power connector adapted to be connected to a female push wire connector which is also part of the kit. The kit may also further contain a compress fit raceway for covering the power source for protection purposes and safety chains to permit the assembled kit to be suspended from the emptied lighting fixture once the kit has been assembled for installation.

In use, a conventional ceiling mounted fluorescent lighting system is stripped of its bulbs, and drivers leaving only the bear light fixture or coffin and the exposed 120 VAC power lines within its emptied interior space. The installer then attaches the mounting brackets to the interior exposed surface of the light fixture spaced for receiving between them the mounting plate which has pre mounted thereto the printed circuit board with the cluster(s) of LEDs and the power source. The user in this regard, simply and easily snaps the preassembled and pretested components into the mounting brackets. The proximal end of the safety chain is then secured to the interior surface of the lighting fixture adjacent to one of the mounting brackets, using kit provided screws, and then the distal end of the chain is secured through the mounting plate to safety chain hole(s) provided in the printed circuit board and the mounting plate. In this manner, should the mounting plate be released from the mounting brackets, the assembled components including the mounting plate, and the components mounted thereto will be suspended by the safety chain preventing the assembly from falling to the floor. Once the assembly has been secured to the safety chain, the user using the kit provided female push wire connector, pushes the 120 VAC lines into the female push wire connector, which in turn is then pushed by the user into the male push wire connector coupled to the power source mounted to the printed circuit board. Once the primary AC power is connected to the installed kit, the user may replace the fluorescent light fixture cover and apply the AC power to the resulting system.

The invention provides a retrofit kit and system that is versatile and convenient to use. In this regard, the retrofit kit and system are configured to be quickly deployed and installed in a conventional fluorescent lighting fixture and system or customized fluorescent lighting fixtures and systems. Because of the unique inter-connection between the power source and the various clusters of LED the lighting system is able to provide at least 100 lumens of forward direct light output for each single watt of power provided.

According to another aspect of the present invention, there is provided a retrofit kit, comprising: a self contained troffer insert for mounting in a previously occupied fixture space, said troffer insert providing N number of LEDs with about 100 percent efficiency.

In certain exemplary embodiments disclosed herein there is provided a new and improved retrofit kit that comprises a self contained source of visible radiant energy configured to replicate, with improved luminance, a light pattern generated by the fluorescent light fixture; wherein the self contained source of visible radiant energy is adapted to be coupled to a universal source of electrical energy and supported by the fluorescent light fixture without modification after the fixture is gutted of its bulbs, ballast, electrical sockets, and ballast cover.

In certain exemplary embodiments disclosed herein there may be provided methods of retrofitting a fluorescent light fixture to provide an improved luminance that comprises is provided a new and improved light fixture that comprises gutting a fluorescent light fixture of its ballast cover and its electrical components including bulbs, ballast, electrical sockets; electrically coupling a self contained retrofit kit to a source of universal electrical energy previously connected to the fluorescent light fixture; removably securing the self contained retrofit kit within the fluorescent light fixture in place and stead of its gutted ballast cover; and energizing said self contained retrofit kit with the source of universal electrical energy so that a plurality of electrical elements disposed on said self contained retrofit kit cast visible radiant energy in a replicated light pattern with improved luminance.

In certain exemplary embodiments disclosed herein there is provided a new and improved retrofit kit that comprises a self contained source of visible radiant energy provided by a plurality of electrical elements coupled to a constant current source which converts electrical energy into visible radiant with improved luminance; and an electrical conversion device mounted to a flexible mounting plate where the electrical conversion device transforms a universal source of electrical energy connected to the fluorescent light fixture into the constant current source; and wherein the flexible mounting plate supports the plurality of electrical elements and the electrical conversion device and is further adapted to be secured removably within a gutted fluorescent light fixture.

In certain exemplary embodiments disclosed herein there is provided a new and improved retrofit kit that comprises a self contained source of visible radiant energy provided by a plurality of electrical elements coupled to a constant voltage source which convert electrical energy into visible radiant with improved luminance; and an electrical conversion device mounted to a flexible mounting plate where the electrical conversion device transforms a universal source of electrical energy connected to the fluorescent light fixture into the constant voltage source; and wherein the flexible mounting plate supports the plurality of electrical elements and the electrical conversion device and is further adapted to be secured removably within a gutted fluorescent light fixture.

In certain exemplary embodiments disclosed herein there is provided a new and improved retrofit kit that comprises a self contained source of visible radiant energy provided by a plurality of electrical elements coupled to a constant power source which convert electrical energy into visible radiant with improved luminance; and an electrical conversion device mounted to a flexible mounting plate where the electrical conversion device transforms a universal source of electrical energy connected to the fluorescent light fixture into the constant power source; and wherein the flexible mounting plate supports the plurality of electrical elements and the electrical conversion device and is further adapted to be secured removably within a gutted fluorescent light fixture.

A feature of the present invention is wherein the plurality of electrical elements are arranged to generate visible radiant energy in X number of substantially straight lines each having a dimension substantially greater in one direction than any in a plane transverse to said one direction.

Yet another feature of the present invention is wherein the X number of substantially straight lines each having a dimension substantially greater in one direction than any in a plane transverse to said one direction is one straight line.

Yet another feature of the present invention is wherein the X number of substantially straight lines each having a dimension substantially greater in one direction than any in a plane transverse to said one direction is four straight lines.

Yet another feature of the present invention is wherein the X number of substantially straight lines each having a dimension substantially greater in one direction than any in a plane transverse to said one direction is six straight lines.

Still yet another feature of the present invention is wherein the flexible mounting plate is a flexible printed circuit board.

Still yet another feature of the present invention is wherein the universal source of electrical energy is a 120 volt, 50 Hertz source.

Still yet another feature of the present invention is wherein the universal source of electrical energy is a 220 volt to 240 volt, 60 Hz source.

In certain exemplary embodiments disclosed herein there is provided a new and improved self contained retrofit kit for a gutted fluorescent light fixture to provide the fixture with improved luminance, that comprises a mounting plate adapted to removably secured within the gutted fluorescent light fixture; wherein the mounting plate has mounted thereto an electrical conversion device that transforms a universal source of electrical power to a constant power source and a plurality of electrical elements which are coupled to said constant power source for converting electrical energy into visible radiant energy with the improved luminance.

The mounting plate may be a flexible mounting plate which has sufficient flexibility to be flexed and snap fit into the gutted fluorescent light fixture after gutted of its bulbs, ballast, electrical sockets and ballast cover.

The mounting plate may be provided with mounting hardware to secure the mounting plate to the gutted fluorescent light fixture after gutted of its bulbs, ballast, electrical sockets and ballast cover.

The plurality of electrical elements are connected in series to form at least one elongate string of elements to replicate a single fluorescent bulb with improved luminance.

The plurality of electrical elements are connected in series to form at least two spaced apart elongate strings of elements to replicate a pair of spaced apart fluorescent bulbs with improved luminance.

The two spaced apart elongate strings of elements are electrically coupled in series by a jumper mounted to said mounting plate.

In certain exemplary embodiments disclosed herein there is provided a new and improved light fixture that comprises a support unit adapted to be mounted to a stationary surface and for providing access to a universal source of electrical energy; a self contained source of visible radiant energy mounted to said support unit and electrically coupled to said universal source of electrical energy for transforming said universal source of electrical energy into visible radiant energy cast in at least one direction to render objects in that direction visible; and wherein the self contained source of visible radiant energy includes: an electrical conversion device for transforming said universal source of electrical energy into a constant power source and at least one electrical element coupled to said constant power source for converting electrical energy from said constant power source into visible radiant energy.

The self contained source of visible radiant energy includes a mounting plate for supporting from below said electrical conversion device to conceal it from view when said self contained source of visible radiant energy is mounted in said support unit and for supporting from above said at least one electrical element so its visible radiant energy is cast downward to light a floor area of a room.

In certain exemplary embodiments disclosed herein there is provided a new and improved light fixture that comprises a support unit adapted to be mounted to a stationary surface and for providing access to a universal source of electrical energy; a strip of non conductive material laid out in a non conductive electrical path within the support unit; a strip of conductive material laid on top of said strip of non conductive material for defining a conductive electrical path; at least one electrical element coupled to said conductive electrical path for converting electrical energy into visible radiant energy; and an electrical conversion device mounted to said support unit for transforming a universal source of electrical energy into a constant power source for supplying said conductive electrical path with a sufficient amount of electrical energy to enable said at least one electrical element to convert the sufficient amount of electrical energy into visible radiant energy.

The foregoing is a summary and thus may contain simplifications, generalizations, inclusions, and/or omissions of detail. Consequently, those skilled in the art will appreciate that the summary is illustrative only and is not intended to be in any way limiting. In addition to the illustrative aspects, embodiments, and features described hereinabove, further aspects, embodiments, and features will become apparent by reference to the drawings and the following detailed description.

### BRIEF DESCRIPTION OF THE DRAWINGS

The invention will be more fully understood by reference to the detailed description in conjunction with the following figures, wherein:

FIG. 1 is an exploded view of a prior art fluorescent lighting system fixture;

FIG. 2 is a view in perspective showing a first self contained retrofit kit installed in a conventional gutted fluorescent light fixture;

FIG. 3 is a top plane view showing a printed circuit board (PCB) with sets of light emitting diodes, the PCB forming part of a second self contained retrofit kit;

FIG. 4 is a side elevational view of the printed circuit board of FIG. 3;

FIG. 5 is an end view of the printed circuit board of FIG. 3;

FIG. 6 is a diagrammatic bottom plane view of a direct current power supply forming part of the retrofit kit and system of FIG. 2;

FIG. 7 is a top plane view of the package construction of a single light emitting diode forming part of the first embodiment retrofit kit of FIG. 2;

FIG. 8 is a side elevational view of the package construction of the light emitting diode of FIG. 7;

FIG. 9 is a bottom plane view of the package construction of the light emitting diode of FIG. 7;

FIG. 10 is a perspective view of a female push wire connector forming part of the first embodiment retrofit kit of FIG. 2, illustrating its daisy change wiring feature;

FIG. 11 is a perspective view of the combination of male and female push wire connectors forming part of the first embodiment retrofit kit of FIG. 2, illustrating their integrated locking latch-automatic locking arrangement with simple push down disengagement;

FIG. 12 is another perspective view of the female push wire connectors of FIG. 13, illustrating its completely touch-proof construction in an unmated position;

FIG. 13 is a perspective view of the combination of male and female push wire connectors of FIG. 2, illustrating the male connector using either stranded or solid copper conductors and the associated female push wire connector clamping solid copper wire conductors;

FIG. 14 is a perspective view of a push wire connector forming part of the first embodiment retrofit kit of FIG. 2, illustrating its two-piece construction with a copper current bar and a stainless steel spring combination to provide optimal contact pressure independent of its housing;

FIG. 15 is another perspective view of the male push wire connectors of FIG. 13, illustrating its completely touch-proof construction in an unmated position;

FIG. 16 is yet another perspective view of the male push wire of FIG. 14, illustrating its 100% mismatching protection construction;

FIG. 17 is a top plane view showing another printed circuit board (PCB) with sets of light emitting diodes, the PCB forming part of a third embodiment retrofit kit;

FIG. 18 is an end view of the printed circuit board of FIG. 17;

FIG. 19 is a side elevational view of the printed circuit board of FIG. 17;

FIG. 20 is specification chart for the light emitting diode of FIGS. 7-9, showing its absolute maximum ratings at a Tₐ temperature of 25 degrees centigrade;

FIG. 21 is a specification chart for the light emitting diode of FIGS. 7-9, showing its electro-optical characteristics at a Tₐ temperature of 25 degrees centigrade;

FIG. 22 is a specification chart for the light emitting diode of FIGS. 7-9, illustrating its chromaticity bin characteristics;

FIG. 23 is a specification chart for the light emitting diode of FIG. 7-9, illustrating the bin data utilized in construction the chart of FIG. 22;

FIG. 24 is an optical characteristic curve for the light emitting diode of FIGS. 7-9, illustrating its spectral distribution of relative intensity vs. wavelength at a Tₐ temperature of 25 degrees centigrade;

FIG. 25 is an optical characteristic curve for the light emitting diode of FIGS. 7-9, illustrating its forward current vs. forward voltage at a Tₐ temperature of 25 degrees centigrade;

FIG. 26 is an optical characteristic curve for the light emitting diode of FIGS. 7-9, illustrating its relative intensity vs. forward current at a Tₐ temperature of 25 degrees centigrade;

FIG. 27 is an optical characteristic curve for the light emitting diode of FIGS. 7-9, illustrating its relative intensity vs. ambient temperature of Tₐ degrees centigrade;

FIG. 28 is an optical characteristic curve for the light emitting diode of FIGS. 7-9, illustrating its derating characteristic of maximum forward current vs. ambient temperature of Tₐ degrees centigrade;

FIG. 29 is an optical characteristic curve for the light emitting diode of FIGS. 7-9, illustrating its forward current vs. chromaticity at a Tₐ temperature of 25 degrees centigrade;

FIG. 30 is an optical characteristic curve for the light emitting diode of FIGS. 7-9, illustrating its characteristics of radiation;

FIG. 31 is a reflow profile for the soldering conditions associated with the light emitting diode of FIG. 7, illustrating it recommended soldering conditions for reflow soldering and hand soldering;

FIG. 32 is a reflow profile chart of temperature vs. time for reflow soldering conditions associated with the light emitting diode of FIGS. 7-9;

FIG. 33 is an illustration of the recommended pad design for the light emitting diode of FIGS. 7-9;

FIG. 34 is an illustration of using a pick up nozzle for applying pressure to an encapsulated part of the light emitting diode of FIGS. 7-9;

FIG. 35 is a reliability chart for the light emitting diode of FIG. 7 illustrating different test items and reliability results;

FIG. 36 is a chart of the criteria for judging the damage that may be detected with the light emitting diode of FIGS. 7-9;

FIG. 37 is a reel loaded with a plurality of the light emitting diodes of FIGS. 7-9, illustrating the feeding direction for discharge of individual ones of the diodes from the reel;

FIG. 38 is a top plane view of the reel of FIG. 37;

FIG. 39 is a side elevational view of the reel of FIG. 38;

FIG. 40 is a dimension chart for the reel dimensions associated with the reel of FIG. 39;

FIG. 41 is an illustration of the dimensions of the reel tape carrying the individual ones of the diodes shown in FIG. 37;

FIG. 42 illustrates the arrangement of the tape of FIG. 41;

FIG. 43 is a flow chart illustrating the packaging specifications and storage conditions for reeled light emitting diode products, label included, inclusive of the light emitting diode of FIGS. 7-9;

FIG. 43A is an identification label used on the reeled light emitting diode products illustrated in the flow chart of FIG. 43;

FIG. 44 is a greatly enlarged partial top plane view of the first embodiment retrofit kit in operative condition to be installed in a gutted fluorescent light fixture, the retrofit kit employing a set of current control resistors;

FIG. 45 is a perspective view of another self contained retrofit conversion kit for a gutted fluorescent light fixture, illustrating a mounting plate with a top mounted power supply and jumper, which self contained retrofit kit is constructed in accordance with the present invention;

FIG. 46 is a perspective view of still yet another self contained retrofit conversion kit for a gutted fluorescent light fixture, illustrating a mounting plate with a bottom mounted power supply, which self contained retrofit kit is constructed in accordance with the present invention;

FIG. 47A is a cross-sectional view of the printed circuit board in FIG. 54 taken substantially along line 47A-47A, wherein individual ones of the diodes are soldered to the substrate and the substrate is adhesively mounted to its associated mounting plate;

FIG. 47 B is a cross-sectional view of another printed circuit board, wherein individual ones of the diodes are soldered to the substrate and the substrate is hardware mounted to its associated mounting plate;

FIG. 47C is a cross-sectional view of the printed circuit board in FIG. 49 taken substantially along line 47C-47C, wherein individual ones of the diodes are solder to a substrate and the substrate is constructed on a troffer face plate;

FIGS. 48-48A are flowcharts illustrating the steps of retrofitting a conventional prior art fluorescent light fixture with any one of the retrofit kits described and illustrated herein;

FIG. 49 is a greatly enlarged top plane view of a troffer mounted printed circuit board constructed in accordance with the present invention;

FIG. 50 is an electrical diagram illustrating how the N number of printed circuit board of FIG. 48, are connected in parallel in a normal operating environment;

FIG. 51 is an electrical diagram illustrating how the X number of LED clusters are connected in parallel on the printed circuit board of FIG. 50;

FIG. 52 is an electrical diagram illustrating how a typical cluster of LEDs are connected in series and interconnected with either a zero ohm resistor bridge or with a current limiting resistor if necessary after testing; and.

FIG. 53 is an electrical diagram illustrating how Y number of LEDs in a typical cluster are connected in series facilitating interconnection with a current limiting resistor if necessary;

FIG. 54 is a top plane view of yet another self contained retrofit conversion kit for a gutted fluorescent light fixture which is constructed in accordance with the present invention;

FIGS. 55-57 illustrate different diode strip configurations for emulating different lighting patterns indicative of a single lighting strip, three lighting strips and six lighting strips respectively;

FIGS. 55A-57A illustrate lighting system constructed in accordance with the present invention where the light emitting elements are directly secured to the inner plate-like surface of a light fixture troffer;

FIGS. 58-59, 59A, and 60-64 illustrate different lighting fixture configurations for use with a retrofit kit constructed in accordance with the present invention;

FIG. 65 is a perspective view of a troffer adapted for receiving therein an assembled first embodiment of the retrofit kit, the first embodiment of the retrofit kit illustrated with a mounting bracket, safety chain and platform supports;

FIG. 66 is a perspective vies of the self contained first embodiment of the retrofit kit, where the self contained kit is temporarily suspended within a gutted troffer for attachment to a high voltage wiring system.

### DETAILED DESCRIPTION OF PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from either the spirit or scope of the invention.

In addition, the present patent specification uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

Prior Art Fixtures

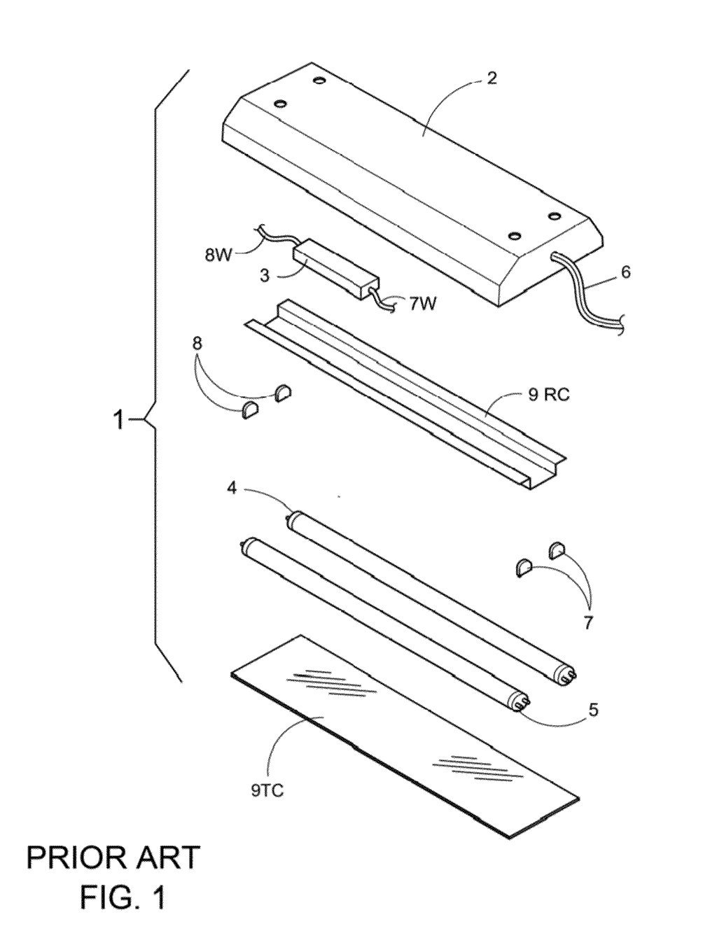

Before disclosing a new and improved lighting system retrofit kit 10 and lighting system 100, it would be beneficial to first briefly review the state of the art relative to recessed lighting fixtures which utilize fluorescent bulbs. In this regard, referring to FIG. 1 there is shown in an exploded perspective view, a prior art conventional fluorescent bulb light fixture 1. As best seen the conventional fixture 1 generally includes a troffer 2 which is adapted to be mounted to a stationary surface, such as a ceiling surface (not shown). The troffer 2 is utilized to support from above the other conventional component of the fixture which includes a ballast 3 for converting high voltage alternating current power, such as 120 VAC power at 50/60 Hz to a corrected voltage for driving a pair of fluorescent light bulbs indicated generally at 4 and 5 respectively. The ballast 3 is electrically coupled by means not shown to a set of high voltage wires 6 and to a set of electrical sockets indicated generally at 7 and 8 by a set of ballast wires indicated generally at 7W and 8W respectively. The electrical sockets 7 and 8 are mounted by mounting hardware (not shown) to the sidewalls of the troffer 2 in order to support therebetween respective ones of the bulbs 4 and 5. In order to conceal the ballast 3, the high voltage wires 6 and the ballast wires 7W and 8W the fixture is further provided with a compress fit raceway cover 9RC. Finally, in order to help disburse the light generated by the bulbs 4 and 5, the fixture is further provided with a translucent cover 9TC which is press fit into the troffer 2 for concealing the bulbs 4 and 5 as well as the raceway cover 9RC. Conventional fixtures, such as the fixture 1 are provided in various lighting configurations of a single bulb, a pair of bulbs, a set of three bulbs and a set of six bulbs. In all such configurations, the bulbs are of a standard length and provided in a tubular form as best seen in FIG. 1.

Considering now the state of the art relative to recessed lighting fixtures which utilize fluorescent bulbs in greater detail, U.S. Pat. No. 4,494,175 issued to Gawad et al. describes a mounting arrangement for affixing a troffer to a lighting fixture. The '175 patent discloses the use of separate fasteners, such as screws for joining together the structural body elements of the disclosed fixture body assembly. In this regard, the lighting system disclosed therein is adapted for use in association with a suspended ceiling structure having a grid support comprised of spacedly positioned grid members. The lighting system disclosed generally includes a fixture housing and a louver assembly. The fixture housing has means at a top portion thereof for supporting a pair of spaced lamp sockets members. The fixture housing is open at the bottom thereof and has a thin, deflectable top plate member secured thereto which forms part of the housing and which defines an optically reflecting surface that is disposed adjacent to the lamp socket members. The lighting system further includes means for securing the fixture housing to the grid support between the spacedly positioned grid members. The louver assembly has a top portion which is adapted to contact the deflectable top plate member and a bottom portion that includes longitudinally extending sides for resting upon and being supported by respective one of the spacedly positioned grid members. The louver assembly is not fixedly attached to the suspended ceiling structure; instead the bottom portions of the louver assembly are adapted to be inserted on each of the grid members in sequence, one and then the other. The deflectable top plate member deflects upwardly in a pivotal manner upon contact with the top portion of the louver assembly during the insertion of the louver assembly on the grid members to facilitate the insertion and thereafter exerting a substantially downward force on the louver assembly to assist in maintaining the louver assembly in position on the grid members. In this manner the louver assembly is supported in the fixture housing without the use of supporting springs, latches or the like.

U.S. Pat. No. 5,823,663 issued to Bell et al. discloses another type of recessed fluorescent troffer lighting fixture particularly intended for recessed mounting to a suspended ceiling grid. In this regard, the '663 patent discloses a housing frame configuration with spaced end plates that secure to a top plate and side flanges without the need for separate fasteners. The end plates, top plate and side flanges of the fixture housing snap-fit together through the use of cooperating fastening elements formed integrally with the end plates inter alia. The fixture housing mounts a louver and a channel with fastening structure integrally formed with the fixture housing, the channel mounting at least one fluorescent lamp and having reflective surfaces opposing the lamp for helping to improve the efficiency of the fixture.

U.S. Patent Application Publication No.: 2009/0196024 filed by Heiking et al. discloses yet another type of ceiling mounted troffer-type light fixture for illumination. The fixture as disclosed in the '024 publication generally comprises a body with a first flange having at least one hook-receiving opening and a second flange with a suspension-member-receiving opening. A cover includes a rectangular frame, at least one catch-arm and at least one suspension member. Frame fasteners along the frame engage the perimeter in a closed position. One-person attaching/closing and removal of the cover for maintenance is facilitated by the cover being supported in an open position, suspended position and fully engaged with the body in a closed position.

From the foregoing, it should be understood by those skilled in the art, that a recessed lighting fixture which utilize fluorescent bulbs may be easily and quickly disassembled or gutted for retrofit purposes, For example, by simply unsnapping component parts from the housing fixture, an installer can quickly gut the fluorescent lighting system, leaving only a bare fixture housing with exposed high voltage wiring. This, as will be explained hereinafter in greater detail, is the first step required for retrofitting the recessed lighting system. Once the lighting fixture has been so gutted, the installer then simply mounts the preassembled troffer insert or retrofit kit 10 of the present invention into the gutted housing; connects the retrofit kit 10 to the exposed high voltage wiring, and then re-establishing an electrical path from a high voltage circuit breaker to the troffer insert, permitting current to flow through the high voltage wiring to energize the retrofit kit 10 and the lighting system 100. In short then, by simply installing alternative mounting hardware (if not already available in the gutted fixture 1), such as a safety chain, a set of mounting platforms and a set of mounting screws, the troffer insert can be easily, quickly and efficiently installed with little effort by the installer to provide a new and highly efficient lighting system.

Because of the many different types and kinds of fluorescent light fixtures and fluorescent lamps (tubes and bulbs) the principles that will be taught hereinafter will be generally directed to a single type of fixture, namely a surface mount strip light fixture. Nevertheless there is no intention by this description to limit the scope of the present invention to only this type of fixture utilizing straight linear tube lamps. In this regard, the principles that will be taught hereinafter may be applied to other types of fixtures and tube types (circular, U-shaped) including compact lamps.

Mounting Plate Troffer Insert with Concealed Power Supply Arrangement

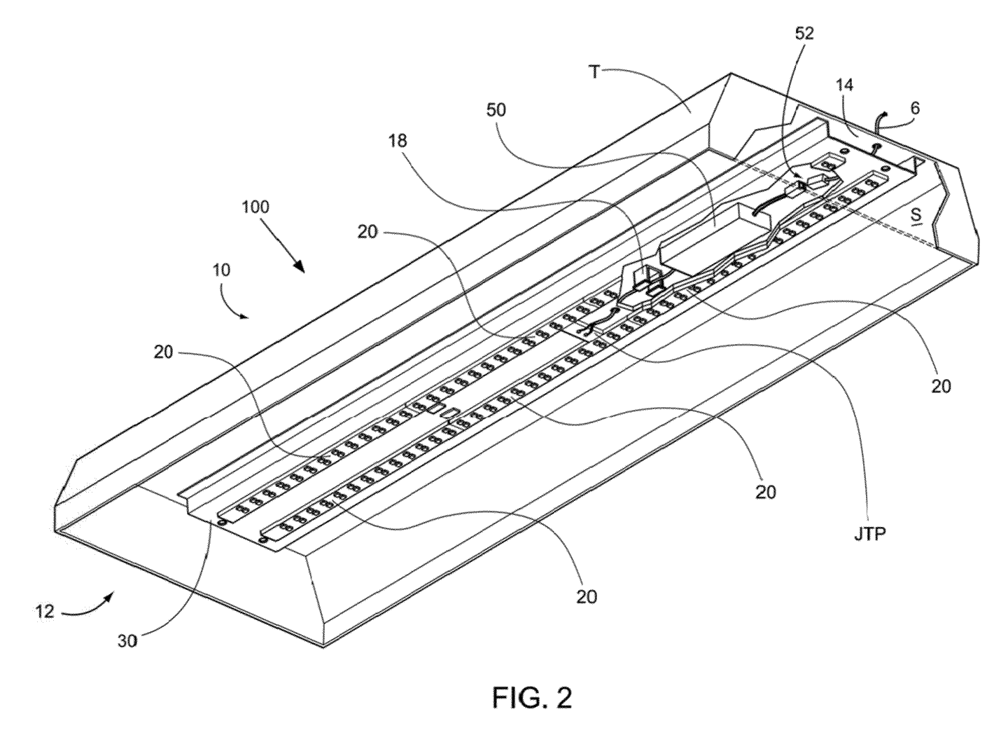

Referring now to the drawings and more particularly to FIG. 2, there is illustrated a first embodiment self contained retrofit kit 10 and a resulting lighting system 100, which kit 10 and lighting system 100 are constructed in accordance with the present invention. The self contained retrofit kit 10 is beneficially used by an installer (not shown) to modify a conventional ceiling mounted fluorescent lighting system by first deleting or gutting the existing ceiling mounted fluorescent lighting system of its reflective surface components, its fluorescent bulb(s), electrical sockets and its ballast components. Once gutted, all that remains of the previous system is a troffer or ceiling recess fixture T, like an inverted trough with its bottom next to the ceiling as best seen in FIG. 2. The installer then simply replaces all of the components gutted from the conventional fluorescent lighting system with the self contained retrofit kit 10 in a fast and convenient manner achieving surprisingly unexpected results. In this regard, as will be explained hereinafter in greater detail, the self contained retrofit kit 10 provides 100 lumens of forwardly directed light output for each single watt of power utilized by the kit 10. This highly efficient unexpected result is achieved and made available in a plurality of different lighting system configurations ranging from a 40-watt, 420 light emitting diode system, to a 60-watt, 600 light emitting diode system, to a plurality of other system configurations using identical, modular LED structures, that provide greater illumination, with less heat, and at a lower cost then that of the replaced conventional ceiling mounted fluorescent lighting system. Other examples include a 20-watt 210 light emitting diode system, a 30-watt 300 light emitting diode system, or even a 10-watt 105 light emitting diode system. There is therefor no intention of limiting the available configuration relative to the size of the power supply converter or the number of light emitting diode as a broad range of different configurations is possible and contemplated.

Referring again to FIG. 2, and as described in more detail hereinbelow, the self contained retrofit kit 10 is adapted to be coupled to a conventional ceiling mounted stationary fluorescent lighting structure, after such a structure has been gutted of its component parts except for the fixture housing T. In this regard, the kit 10 generally includes a self contained, pre-tested troffer insert 12 that is adapted to be directly mounted to an upper wall area or troffer face plate, indicated generally at 14 by any conventional mounting means, such as with screws, twist clips, brackets, rivets or a snap-in arrangement. FIG. 2, illustrates a twist clip arrangement indicated generally at 18. This type of retrofit kit 10 would be typically utilized in a bottom mounting environment.

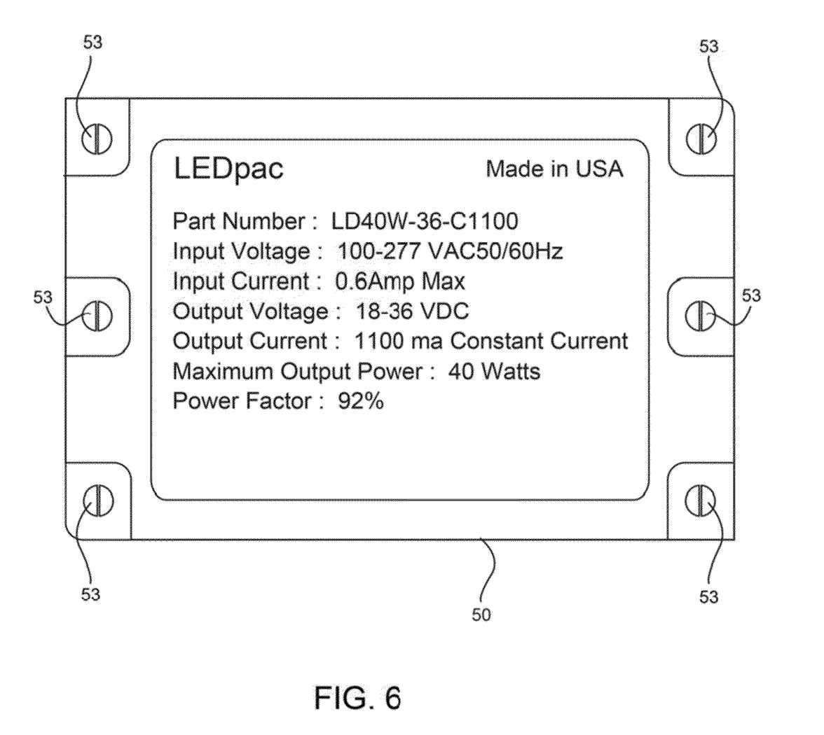

The troffer insert 12 is self contained and merely needs to be 1) electrically connected to the high voltage wires 6 utilized to energize the previously gutted fluorescent lighting system and then 2) mounted in the empty troffer (the gutted fluorescent light fixture). Connecting the troffer insert 12 to the high voltage wires previously utilized to energize the gutted lighting system is done quickly and easily as the troffer insert 12 is provided with a push wire connector system 52 that will be described hereinafter in greater detail. For the moment it will simply suffice to state that the push wire connector system 52 allows either solid or stranded wires to be connected to the troffer insert 12 and an associated constant current power supply, such as a power supply 50 as best seen in FIG. 6. It should be understood by those skilled in the art, that the troffer insert 12 may also be connected to the incoming high voltage service by a set of wire nuts, indicated generally at 78 in FIG. 66. However, by providing the retrofit kit 10 preinstalled with the push wire connector system 52, it is much easier and more convenient to make the high voltage service connection to the troffer insert 12.

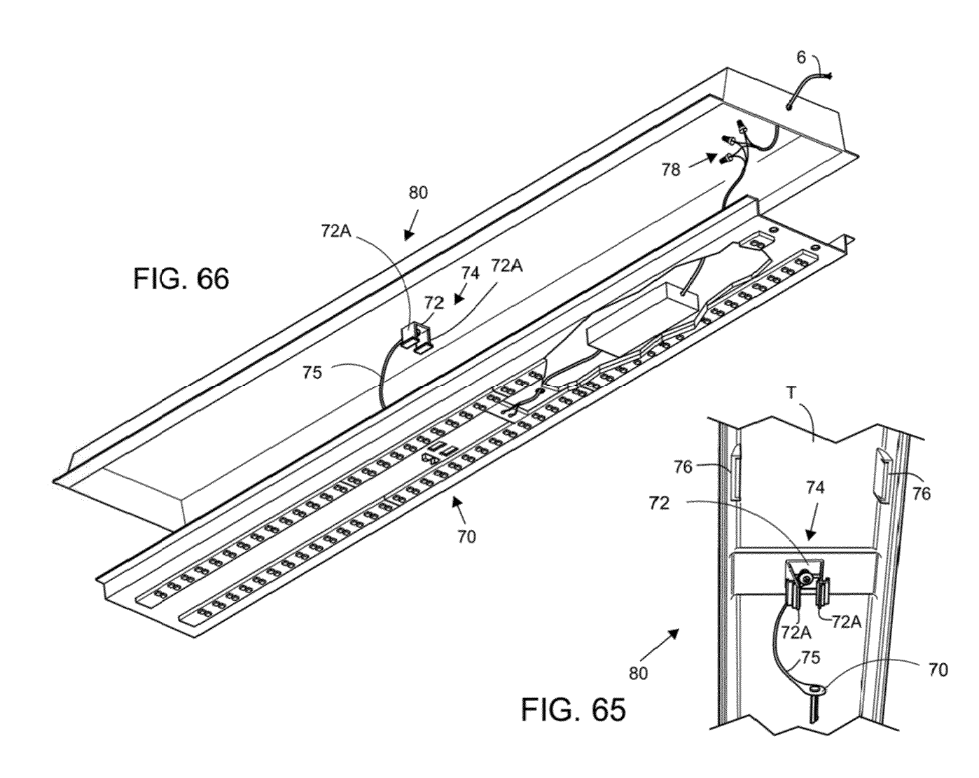

The self contained retrofit kit 10 may be provided with additional mounting hardware to facilitate the quick and easy installation of the troffer insert 12. In this regard, the retrofit kit 10 further includes a troffer insert mounting arrangement indicated generally at 80 (FIG. 65) that will be described hereinafter in greater detail. To suffice for the moment, it should be understood the mounting arrangement 80 may be easily and quickly installed in the gutted troffer T for initially temporarily holding the troffer insert 12 within the troffer T while the high voltage wires 6 are coupled to the push wire connector system 52 or to a set of wire nuts 78 in the alternative. Once the high voltage service has been coupled to the troffer insert 12, the mounting arrangement 80 may then be utilized to removably hold the troffer insert 12 within the troffer T for the intended use of the troffer insert 12 and so that the troffer insert 12 may be serviced or maintained as needed in the future. The mounting arrangement 80 is only needed if similar mounting hardware was not provided in the gutted fixture 1.

As noted earlier herein, the self contained 10 may be configured to provide substantially any luminance level through the utilization of one or more like modular light emitting diode (LED) boards, such as an LED board 20 as best seen in FIG. 2. The following are three examples of using like modular LED boards:

### Example 1

### A 40-Watt, 420 LED Configuration

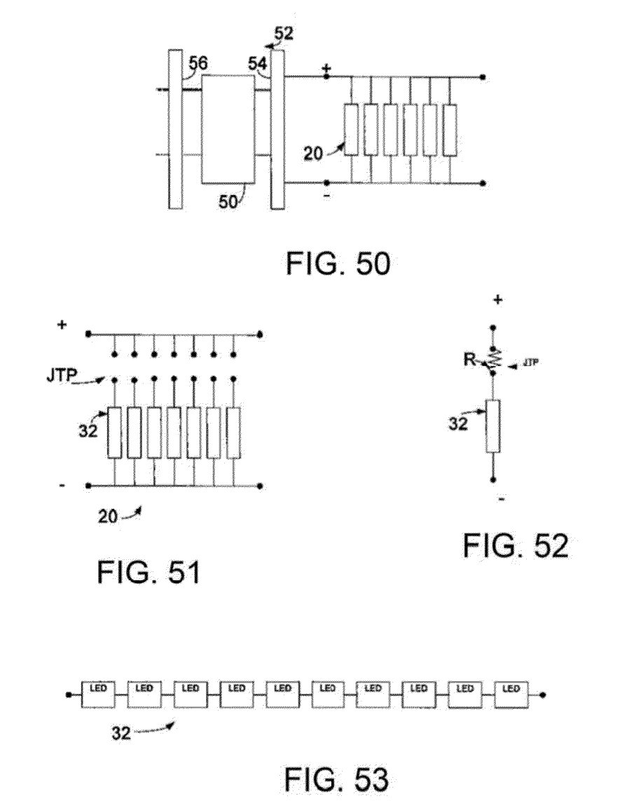

Six-identical boards, such as printed circuit board 20 connected in parallel to a 40-watt constant current power supply 50 as best seen in FIG. 50. Each LED board 20 contains seventy (70) LEDs rated 30 mA, at 3.5V max. The LEDs are arranged in seven (7) clustered groups of 10 LEDs each. A variable resistance path is established in series relative to each one of the individual cluster groups, such as a cluster group 32, as best seen in FIGS. 51 and 53. The variable resistance path in this instance is provided for controlling a constant current in an individual cluster group, to make certain the current is controlled sufficiently to avoid over driving any one of the LED in such an individual cluster group. In this regard, as will be explained, the resistance R that may be added as best seen in FIG. 52 to any given cluster of LEDs may vary between zero (0) ohms and (N) ohms, where N can be any valve between zero (0) and fifty (50). In short, the highly efficient unexpected luminance output result is achieved by matching the individual LED electrical characteristics with the 40-watt constant current power supply 50 thereby eliminating the normally provided in-series resistance typically encountered with each individual one of the LEDs. An electrical bridge test point is disposed at each one of the individual cluster groups and is utilized to determine what resistance amount, if any, should be utilized with a cluster for fine tuning the constant current value used in driving the LED cluster.

Calculating System Efficiency:

The efficiency of the lighting system 100 can now be calculated as follows:

The 40-watt constant current power supply 50 provides a constant current of about 1100 mA. There are six (6) identical printed circuit boards, such as printed circuit board 20, connected in parallel to the 40-watt constant current power supply 50. Each board 20 contains 70 LEDs, where each LED is rated at 30 mA max, 3.5V max. The LEDs are arranged in 7 groups or clusters, where each individual cluster 32 of 10 LEDs is connected in series. The expected and preferred voltage drop across each individual cluster is about 32 volts or less. Accordingly, the power for each group of 10 LED is calculated as:

0.0262 amps(×)32 volts=0.8384 watts

For the entire 420 LED load the power is calculated as follows:

0.8384(×)42=35.218 watts

Based on these power consumption calculations we find the total power consumption inclusive of the power supply 50 is about 40.4 watts. Therefore, the lighting system 100 is achieving about 10 lumens when the current is at 27.8 mA. The total lumen output is then given by multiplying the lumen output of each individual LED (10 lumens) by the total number of LEDs (420) resulting in a total lumen output of about 4200 lumens. Total efficiency is therefore 100 lumens with no current limiting resistors and if a 30 ohm current limiting resistor is placed in each series connected cluster, the total efficiency is about 98.59 lumens.

### Example 2

### A 60-Watt, 600 LED Configuration

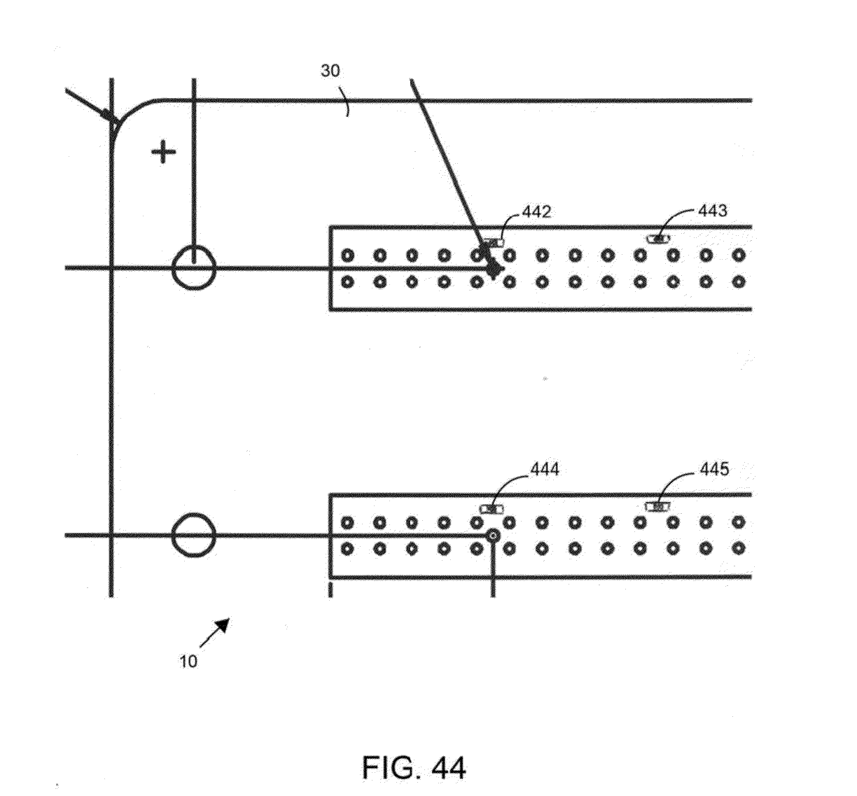

Six-identical boards connected in parallel to a 60-watt constant current power supply. Each board contains one hundred (100) LEDs rated 40 mA, at 3.5V max. The LEDs are arranged in ten (10) clustered groups of 10 LEDs each, with a variable resistance path being established in series with each one of the individual cluster groups. The variable resistance path in this instance, is provided for controlling a constant voltage with the individual cluster group and in this regard, the resistance may vary between zero (0) ohms and (N) ohms, where N can be any valve between zero (0) and fifty (50). In short, the highly efficient unexpected luminance output result is achieved by matching the individual LED electrical characteristics with the 60-watt constant current power supply thereby eliminating the normally provided in-series resistance typically encountered with each individual one of the LEDs. An electrical bridge test point is disposed at each one of the individual cluster groups and is utilized to determine what resistance amount, if any, should be utilized with a cluster for fine tuning the constant current value used in driving the LED cluster. FIG. 44 is a greatly enlarged partial top plane view of the first embodiment retrofit kit 10 in operative condition, illustrating the retrofit kit 10 employing a set of current control resistors 442-445.

### Example 3

### A 40-Watt, 600 LED Configuration

Six-identical boards connected in parallel to a 40-watt constant current power supply. Each board contains one hundred (100) LEDs rated 30 mA max, at 3.5V max. The LEDs are arranged in ten (10) clustered groups of 10 LEDs each, with a variable resistance path being established in series with each one of the individual cluster groups. The variable resistance path in this instance, is provided for controlling a constant voltage in the individual cluster groups and in this regard, the resistance may vary between zero (0) ohms and (N) ohms, where N can be any valve between zero (0) and fifty (50). In short, the highly efficient unexpected luminance output result is achieved by matching the individual LED electrical characteristics with the 40-watt constant current power supply thereby eliminating the normally provided in-series resistance typically encountered with each individual one of the LEDs. An electrical bridge test point is disposed at each one of the individual cluster groups and is utilized to determine what resistance amount, if any, should be utilized with a cluster for fine tuning the constant current value used in driving the LED cluster.

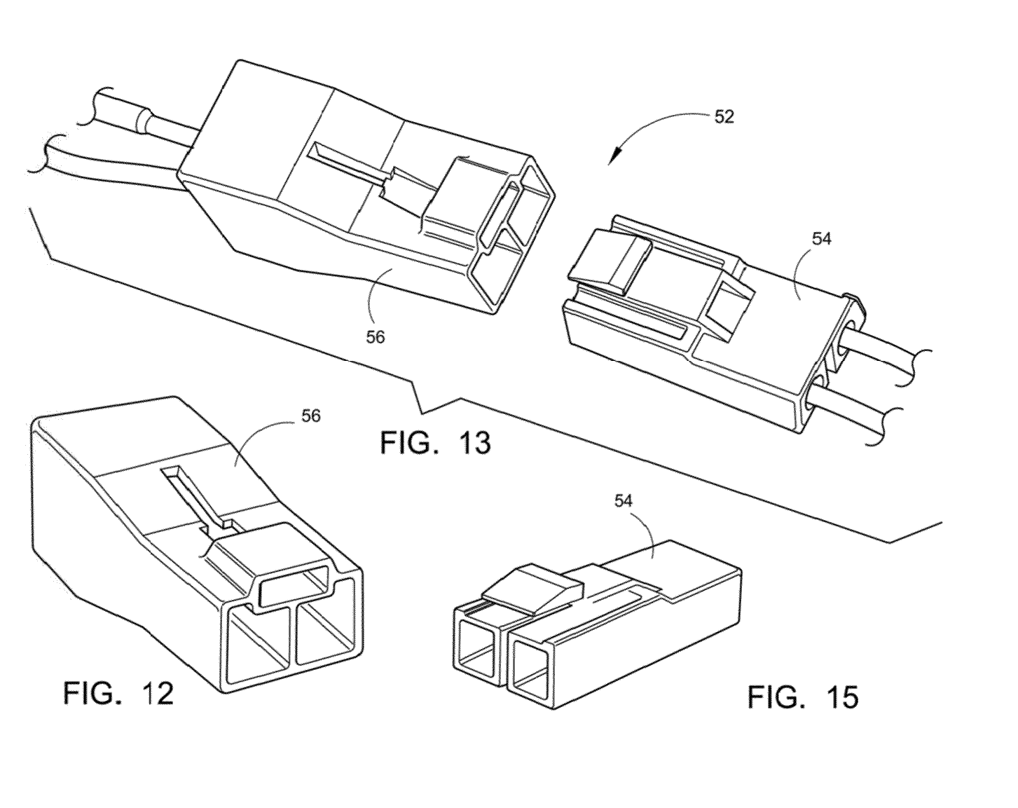

Considering now the self contained, pre-tested troffer insert 12 in greater detail with reference to FIG. 2, the troffer insert 12 generally includes an mounting plate 30, a direct current power supply 50 (FIG. 6), and a plurality of like pretested modular LED printed circuit boards, such as a LED printed circuit board 20. The direct current power supply 50 is electrically coupled to the LED printed circuit boards 20 by a jumper board JTP for supplying them with a source of constant direct current. The direct current power supply 50 is further provided with a push wire connector system 52 (FIG. 13) which is adapted to be easily and quickly connected to a set of high voltage wires remaining after gutting as previously explained.

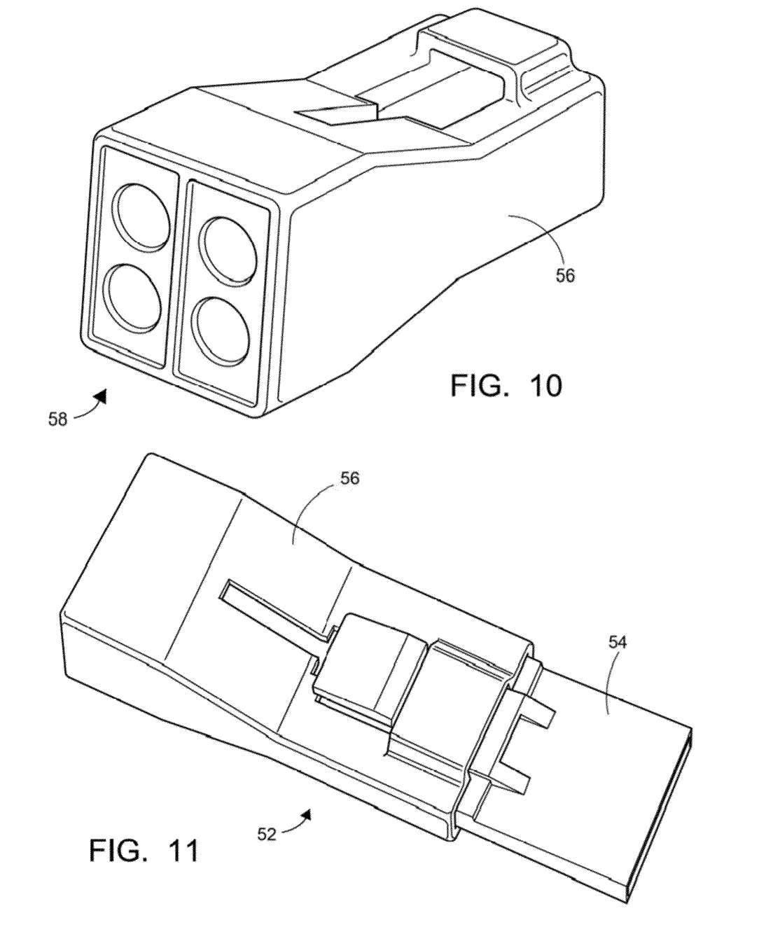

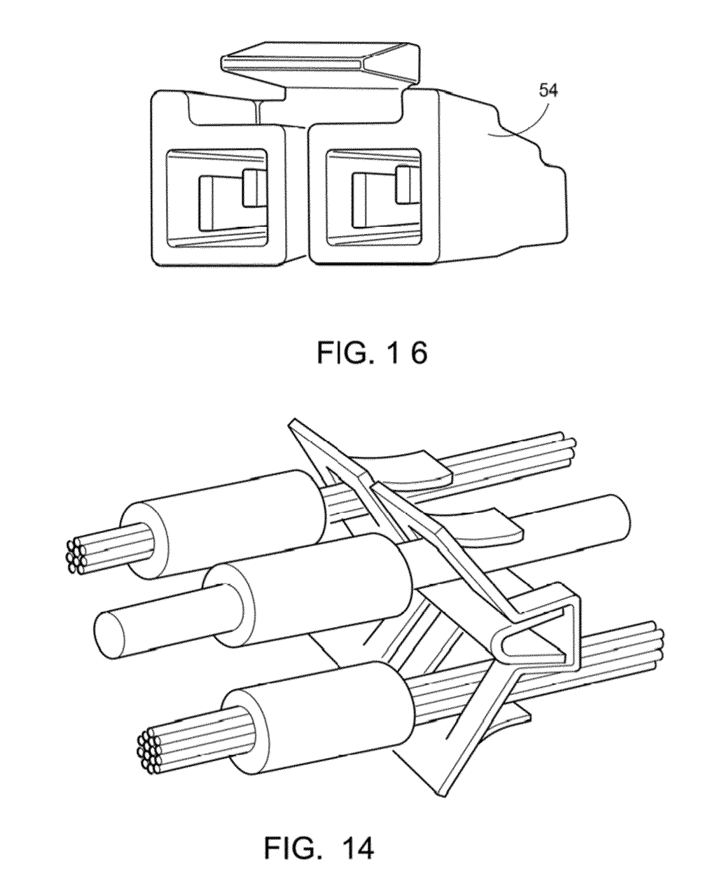

As best seen in FIGS. 10-16, the push wire connector system 52 includes a male connector 54 and a female connector 56 which are releasably connected. In this way, an installer of the troffer insert 12, disconnects the female connector 56 from its male counter part 54, inserts or pushes the high voltage wire into the female connector 56 and then returns the female connector 56 into electrical engagement with the male connector 54. As best seen in FIG. 10, the female connector 56 is provided with a daisy chain feature, indicated generally at 58, which allows the set of high voltage wires (not shown) coming into the connector to be daisy chained out so high voltage may be provided to another power supply should additional power be required because of the set size of light emitting diodes that must be illuminated in a larger lighting system. Sufficient details of the push wire connector system 52 as well as the male connector 54 and the female connector 56 are provided in FIGS. 10-16 and thus, the push wire connector system 52 will not be described hereinafter in any further detail except to state that WAGO corporation located at N120 W19129 Freistadt Road, Germantown, Wis. 53022 manufactures and sell and such connectors which are identified as their Luminaire Disconnect Connector, Series 873, LumiNuts®.

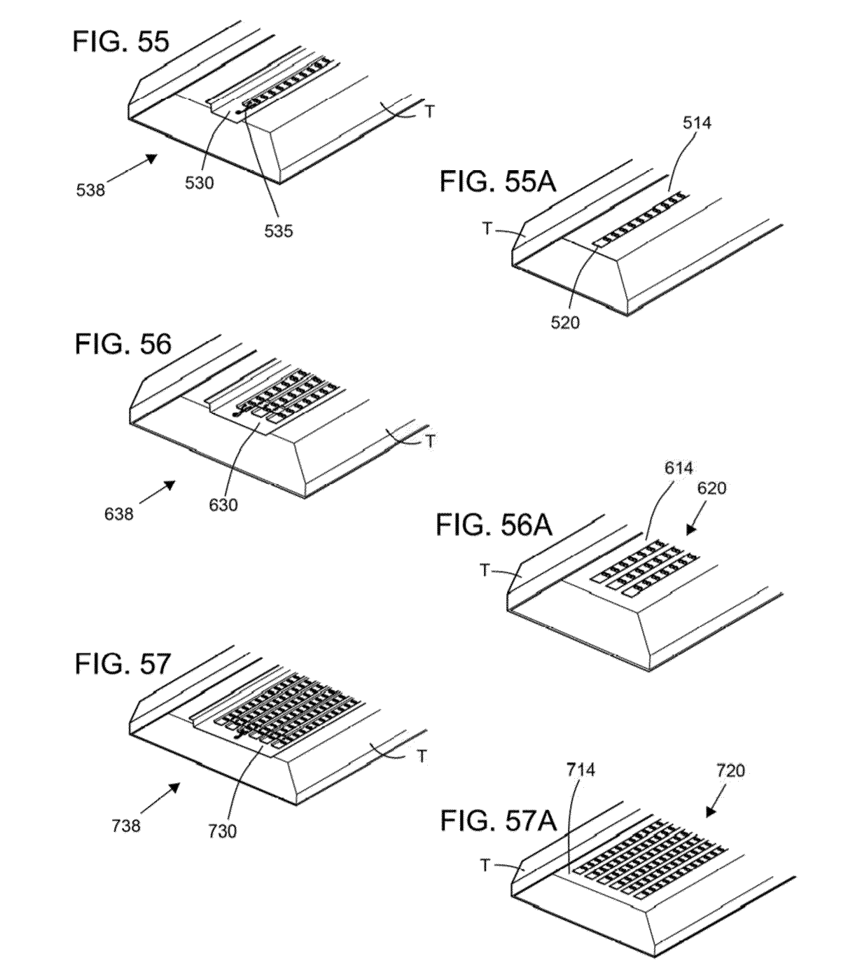

Considering now the mounting plate 30 in greater detail, the mounting plate 30 is dimensioned to be received within the housing space S previously made available through a process of gutting the conventional ceiling mounted stationary fluorescent lighting structure. For simplifying purposes the discussion that follows will be directed to a mounting plate 30 having a generally rectangular configuration with sufficient length and width dimensions to be received within the housing space S. It should be understood however, by those skilled in the art that the mounting plate 30 may be configured in any desired configuration which will be received within a vacated troffer space S. As will be explained herein after in greater detail, in a manufacturing setting as opposed to a field retrofit setting, the mounting plate may become the bottom or face plate 14 of the troffer T itself, so the entire lighting system is manufactured directly to the troffer T without the need of a separate and distinct mounting plate 30. For example, as best seen in FIGS. 55-57 and FIGS. 55A-57A different configurations of modular LED boards, such as the LED board 20, are illustrated. In this regard, as best seen in FIGS. 55-57, the boards 20 are illustrated mounted to mounting plates, such as the mounting plates 530, 630 and 730 respectively. Similarly, in FIGS. 55A-57A, the modular boards, such as the modular board 20, are shown mounted to the face plate of the troffer. From the foregoing, it should be understood by those skilled in the art that when the modular diode boards are installed directly to the face plate of a troffer, the provided power supply converter supplying the driving low voltage to the boards, is installed at about where the high voltage service enters the troffer T. For clarity purposes in FIGS. 55A-57A, the power supply converter has not been shown but it should be understood that low voltage is provided to the various ones of the modular LED printed circuit boards. There is therefore no intention of limiting this disclosure to a mounting plate having a specific geometric configuration or limiting to where the modular LED boards may be mounted within a troffer.

Considering now the mounting plate 30 in greater detail with reference to FIG. 2, the mounting plate 30 is a flexible plate having sufficient flexibility to be flexed and snap fit into the fluorescent light fixture after gutted of its ballast, electrical sockets and ballast cover. The mounting plate 30 is further dimensioned to have mounted thereto a direct current voltage supply 50 (FIG. 6) and a plurality of identical modular LED boards, such as a modular LED board 20 as best seen in FIG. 2. The direct current voltage supply 50 is a standard off the shelf constant current voltage supply, such as a 40-watt supply LD40W-36-C1100 or a 60-watt supply LD60W-36 that is sold by LEDpac located in Escondido, Calif. 92026 or manufactured and sold by SHENZHEN YIGUANG TECHNOLOGY CO., LTD located in Guangdong, China. As these supplies are standard off the shelf items they will not be described hereinafter in greater detail unless necessary for clarity.

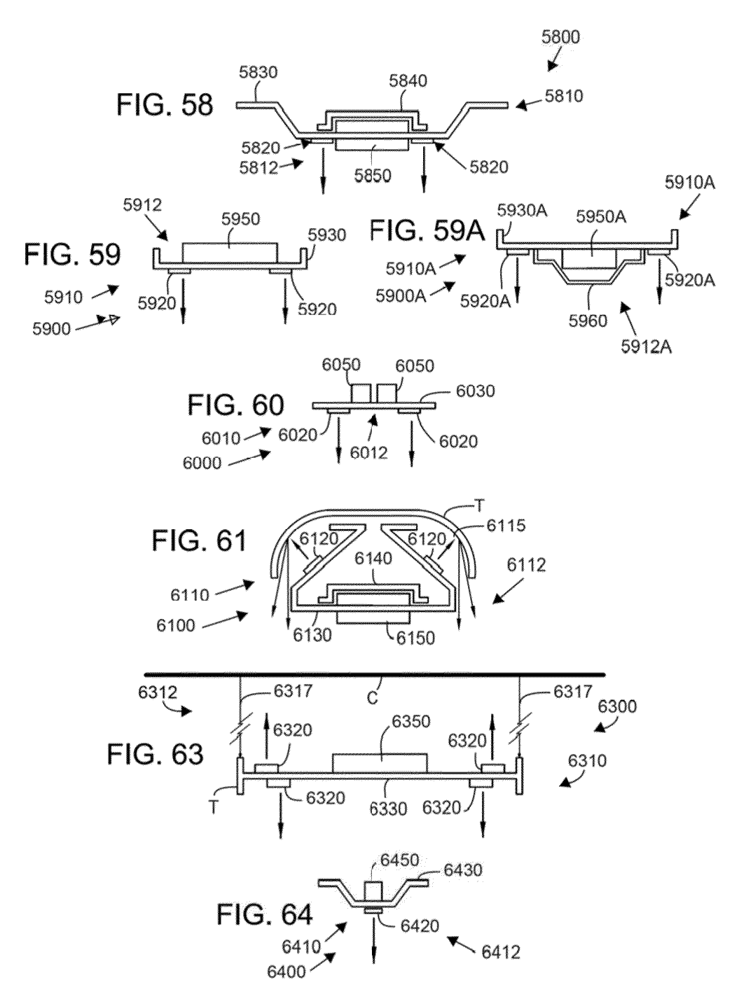

For this self contained kit 10, the mounting plate 30 is adapted to have mounted thereon six (6) identical modular LED boards 20, which are mounted in two separate strips of three (3) identical boards each, where each individual board is indicated generally at 20. The six (6) identical modular LED boards are connected in parallel with one another on the mounting plate 30 as best seen in FIG. 2. The reason for the two separate strips of boards is to provide the retrofit fixture, with the same type of light output pattern that was previously provided by the fluorescent bulbs, but with improved luminance. It should therefore be understood by those skilled in the art there is no intention of limiting this disclosure to two spaced apart strips. For example in FIG. 55, a single strip of LEDs 538 with N number of LED printed circuit boards arranged in parallel is shown. In FIG. 56 a set 630 of three strips with N number of LED printed circuit boards is shown; and in FIG. 57 a set 730 of six strips with N number of LED is shown. In this regard, any N number of strips can be structure to provide a linear light pattern across any longitudinal length, so long as the power supply is sufficiently designed to drive such an extended length of LEDs. It should also be understood by those skilled in the art that the diodes strips and power converter (not shown) may be mounted directly to the troffer base plate or face plate as best seen in FIGS. 55A-57A or still yet the diodes may be configured with different lighting effects with different mounting configuration such as shown in FIGS. 58-64, which when compared to FIGS. 55-57 of N number of diodes, illustrates that the disclosed kit may be applied equally well to a lighting system 6400 with a kit 6410 to retrofit a fixture 6430 with a single light emitting diode 6420 driven by a small singular power supply 6450.

As best seen in FIGS. 50-53 the individual LED's or electrical elements on each board 20 are arranged in clusters 32 of 10 LEDs each, where the LEDs in each duster 32 are connected in series with each other and are further connected in series with a jumper test point JTP pad. The electrical elements are connected in series to form at least one elongate string of elements to replicate a single fluorescent bulb with improved luminance. The jumper test point JTP pad is configured or adapted to allow the series connected LEDs to be placed in series with either a zero ohm electrical bridge R₀ or in the alternative with a current limiting resistor R₁ as will be explained shortly. Each modular board 20 is further adapted to be connected in parallel with another modular LED board 20, or in the alternative, to a source of power.

Before any given modular LED board 20 is connected in parallel with another modular LED board 20 on the mounting plate 30, each individual board 20 is first tested to determine whether a current limiting resistor R or a zero ohm electrical bridge R, should be placed in series with the individual LED clusters, such as a cluster 32. In this regard, a resistor R may be necessary if the current at the test point node JTP at a given cluster 32 is excessive due to the variance in LED voltage drops across the duster 32. Stated otherwise, the individual LEDs in each duster 32 are each rated at 30 mA max, with a 3.5V, max rating. In this regard, when a string of such LEDs are driven by a constant current power supply, such as the direct current voltage supply 50 which delivers 1100 mA of constant current, the voltage drop across the cluster of LEDs should be 32 volts or less based upon their individual ratings. However, standard off the shelf LEDs do not have precise voltage ratings, e.g. some are at 3.1V, 3.2V, 3.3V, 3.4V and some at 3.5V. Because of this variance, the in-factory technician wants to make certain that the current flow at the test point node JTP is not so excessive to cause an LED failure. In other words the voltage drop across the duster string of LEDs should be 32 volts or less based upon a maximum voltage rating of 3.5 volts for each LED in the duster string. So when a technician measures the voltage drop at the node JTP, the technician will either place a zero ohm bridge resistor R or a current limiting resistor R in series with the LED cluster string to control the current traveling through the individual ones of the LEDs in the string so as to make certain that the current in the string will not be excessive overdriving any one of the LEDs in the string. If the voltage drop is at 32 volts or less, the zero ohm resistor bridge R will be placed in series with the LED cluster string. If the voltage drop is greater than 32 volts then the current limiting resistor R will be placed in series with the LED duster string. In short then, a resistor R will be placed in series with the LED string, where the resistor R having a value of between about zero ohms and between about 30 to 50 ohms depending upon the current value determined at the test point JTP. In summary then, the resistor R is placed in series with the LED cluster to help maintain a constant current and voltage level across the set of LEDs disposed on the modular boards 20. The procedure followed by the in-factory technician to test each cluster 32 using a standard oscilloscope or other test equipment would be a conventional procedure which could also be automated and therefore such a procedure will not be described hereinafter in greater detail.

Although the modular LED board 20 has been described with each duster string having a JTP pad which is adapted to allow the series connected LEDs to be placed in series with a zero ohm electrical bridge R or in the alternative with a current limiting resistor R, it is contemplated that as an alternative, a removable zero ohm bridge may be partially installed initially during the manufacturing phase of the board 20, so it is not connecting to another cluster. In this regard, the removable zero ohm bridge may be removed and replaced with a current limiting resistor R at the time of testing if necessary to control or reduce the current because the voltage drop is too high across the cluster, or it may be soldered in place to provide a connection when needed to the other clusters after all the clusters have been tested. This structure would expedite the testing procedure as it is contemplated that most of the LEDs in any given cluster tested will function within their preferred operating voltage range, where individual ones of the LED have a preferred operating voltage of between about 2.5V and about 3.5V. A more preferred voltage is between 2.9 V and about 3.3V and a most preferred voltage is between about 3.0V and 3.1V.

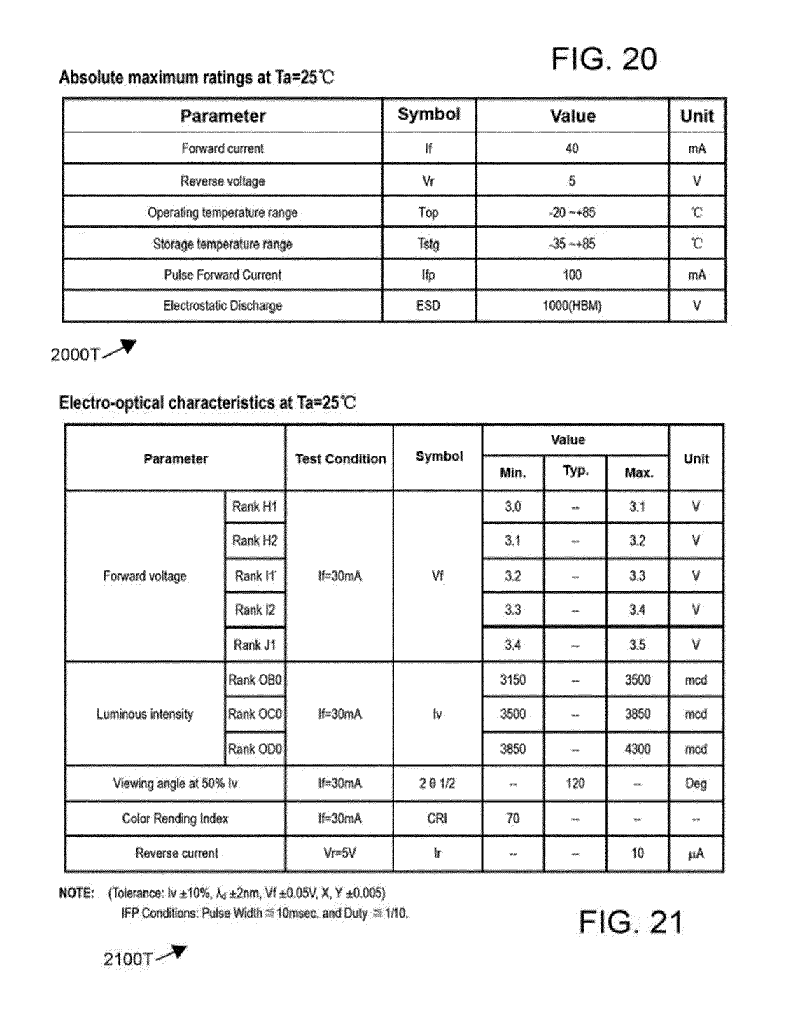

The LEDs within any given duster 32 may be manufactured by numerous LED manufacturers. One manufacturer for example is SHENZHEN REFOND OPTOELECTRONICS, LTD, located in Shenzhen, Peoples Republic of China. For further details regarding the structure and operating characteristics of light emitting diode, reference should be made to FIGS. 20-43 as provided herein for reference. Further, for reference purposes in this disclosure, the LEDs on the individual printed circuit boards are merely referred to generically as LED without the use of any further reference characters.

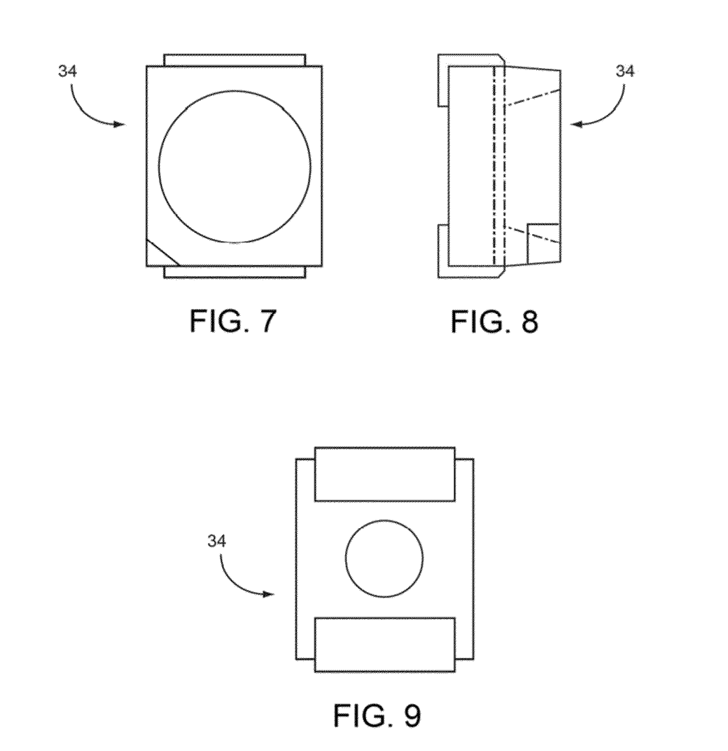

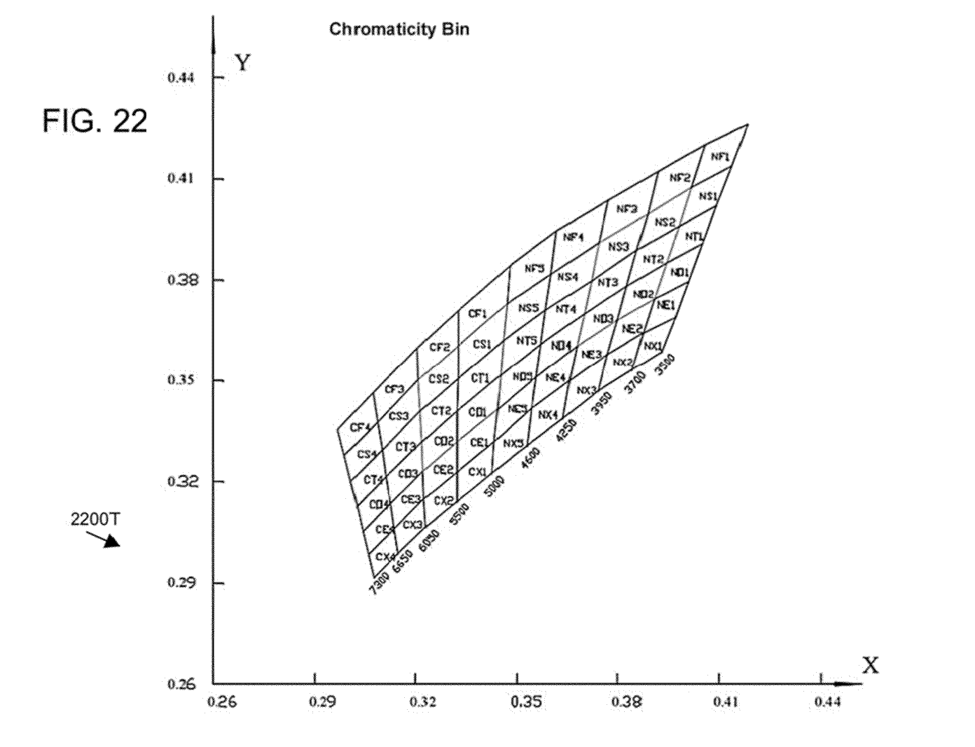

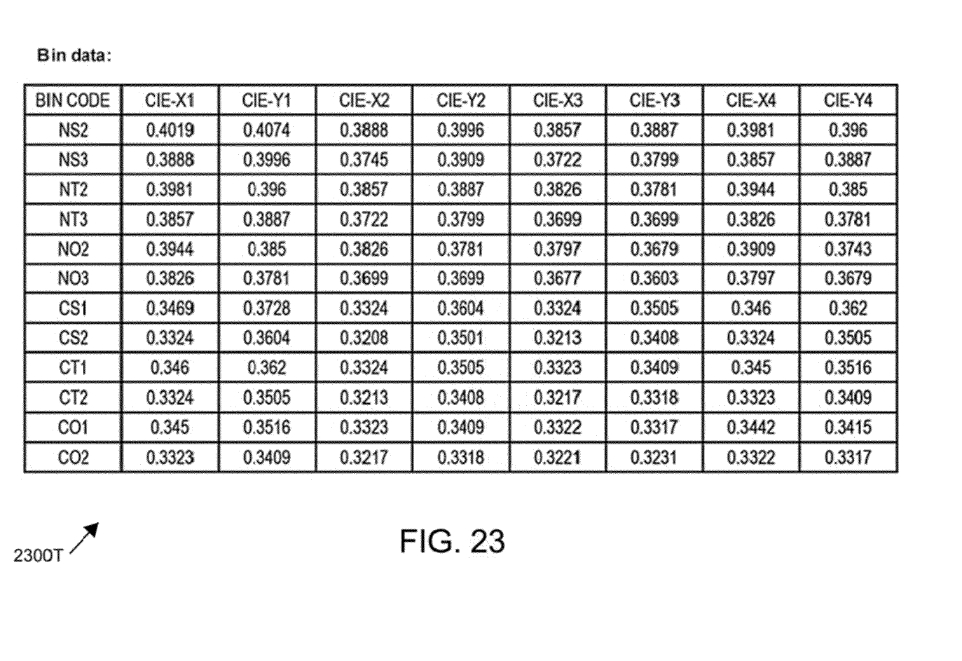

Considering now the characteristics of the light emitting diodes in greater detail, FIG. 20 is a specification chart or table indicated generally at 2000T that shows for the light emitting diode of FIGS. 7-9, its absolute maximum ratings at a Tₐ temperature of 25 degrees centigrade. FIG. 21 provides a specification chart or table 2100T for the light emitting diode of FIGS. 7-9, illustrating its electro-optical characteristics at a T temperature of 25 degrees centigrade. FIG. 22 provides another specification chart or table 2200T for the light emitting diode of FIGS. 7-9, illustrating its chromaticity bin characteristics, while FIG. 23 provides yet another specification chart or table 2300T for the light emitting diode of FIG. 7-9, illustrating the bin data utilized in construction the chart of FIG. 22.

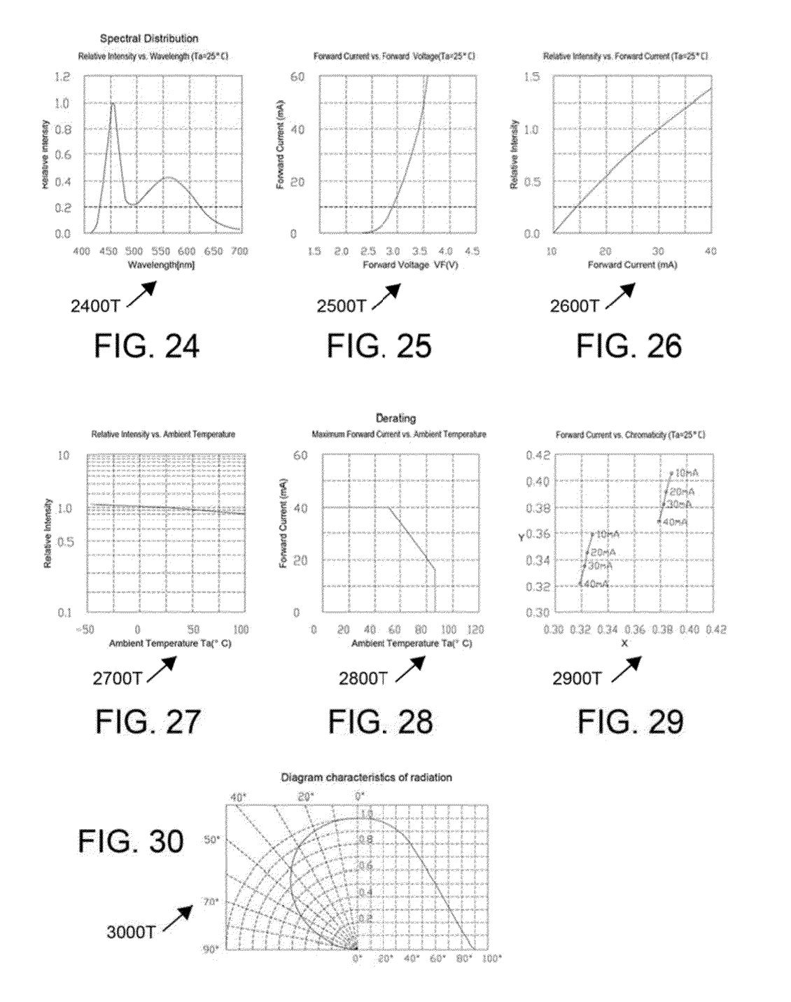

Considering the light emitting diode characteristics in still further detail, FIG. 24 is an optical characteristic curve 2400T for the light emitting diode utilized in the present invention, illustrating its spectral distribution of relative intensity vs. wavelength at a Tₐ temperature of 25 degrees centigrade. FIG. 25 is another optical characteristic curve 2500T, illustrating forward current vs. forward voltage for the light emitting diode at a Tₐ temperature of 25 degrees centigrade. FIG. 26 is yet another optical characteristic curve 2600T for the light emitting diode of FIGS. 7-9, illustrating its relative intensity vs. forward current at a Tₐ temperature of 25 degrees centigrade, while FIG. 27 is still yet another optical characteristic curve 2700T that illustrates its relative intensity vs. ambient temperature of Tₐ degrees centigrade. FIG. 28 is still another optical characteristic curve 2800T for the light emitting diode of FIGS. 7-9, illustrating its derating characteristic of maximum forward current vs. ambient temperature of Tₐ degrees centigrade; FIG. 29 is an optical characteristic curve 2900T for the LED, illustrating its forward current vs. chromaticity at a Tₐ temperature of 25 degrees centigrade; and FIG. 30 is yet another optical characteristic curve 3000T, illustrating its characteristics of radiation.

In summary then, the mounting plate 30 may be provided with mounting hardware to secure the mounting plate 30 to the fluorescent light fixture after gutted of its ballast, electrical sockets and ballast cover, whenever the gutted light fixture is not provided with such mounting hardware. If the gutted light fixture contained a raceway cover, the gutted light fixture should have sufficient mounting hardware for supporting the mounting plate 30 therein without the need of providing or using the optional mounting hardware 80.

Considering now the modular circuit board 20 in greater detail, the modular circuit board 20 is adapted to be mounted directly to the flat surface area of the mounting plate 30. Each modular circuit board 20 is further adapted to be electrically coupled to either another modular circuit board 20 or to the direct current power supply 50 by the push wire connector system, such as the push wire connector system 52. In one preferred embodiment, the low voltage output side of the direct current power supply 50 is coupled to a jumper board JTP which functions to couple the low voltage to either a single circuit board 20 or to a pair of spaced apart circuit boards as best seen in FIG. 54. The exact number of jumper boards JTP utilized is determined by the size of the light system. In this manner, the individual modular circuit boards 20 may be connected either in series or in the preferred parallel connection as described herein for achieving maximum efficiency. The modular printed circuit boards 20 are of standard printed board construction and have a 94V rating. As this type of construction is conventional it will not be described hereinafter in greater detail.

In summary then, it should be understood by those skilled in the art that the first embodiment retrofit kit 10 and lighting system 100, which are constructed in accordance with the present invention, may be configured to provide different levels of luminance, with different efficiencies. For example, for a lighting system 200 with a 40-watt power supply delivering 1100 mA of current to a group of 600 LEDs on 6 identical boards, the power on 10 LEDs is given by the following formula:

Power₁₀=0.0183 amps(×)32 volts=0.586 watts

Therefore power on the total of 600 LEDs is given by:

Powerₜₒₜₐₗ=0.586 watts(×)60=35.15 watts

Since the power supply provides about 40.4 watts, we find the system is delivering about 6.3 lumens when the current is 18.3 mA. Total luminance output then for the 600 LEDs is about 3780 lumens giving a total efficiency of 94 lumens/watt when zero ohm resistor bridge are installed. When 50 ohm resistors are installed to reduce excess current, the efficiency drops to about 91.3 lumens per watt.

As another example, for a lighting system 300 with a 60-watt power supply and six (6) identical boards with 100 LEDs on each board we find the following efficiencies:

Power₁₀=0.0278 amps(×)32 volts=0.8896 watts

Therefore power on the total of 600 LEDs is given by:

Powerₜₒₜₐₗ=0.0278 watts(×)60=53.376 watts

Since the power supply provides about 61.2 watts, we find the system is delivery about 10.2 lumens when the current is about 27.8 mA. Total luminance output then for the 600 LEDs is about 6120 lumens giving a total efficiency of about 100 lumens per watt when the zero ohm resistor bridges are installed. When 30 ohm resistors are installed to reduce excess current, the efficiency may drop to about 97.79 lumens per watt.

Referring now to FIGS. 65 and 66, the mounting arrangement 80 is illustrated in greater detail. In this regard, the mounting arrangement 80 generally includes a set of support or cover snaps, such as the support snap 76, and a mounting bracket arrangement 72 having a set of spaced apart mounting brackets, such as a mounting bracket 72A. The spaced apart mounting brackets 72A are spaced to receive and support from below the mounting plate 30. A set of support snap brackets indicated generally at 76 receives and supports either a mounting plate or a printed circuit board substrate. In this regard, the mounting plate or in the alternative printed circuit board substrate is supported both from below and from the side for safety purpose. In either case, there is sufficient space provided between the base of the troffer T and the bottom of the mounting bracket 72 to permit a direct current power supply, such as the power supply 50 to be mounted to the bottom surface of a mounting plate as seen in FIG. 59 or within the mounting plate itself as best seen in FIG. 58. For the purpose of mounting the power supply 50 to the undersurface of the mounting plate 30, the mounting plate 30 is provided with a set of power supply mounting holes or apertures (not shown) that receive the power supply mounting hardware (screws and self locking nuts) indicated generally at 52 in FIG. 6.

As best seen in FIG. 65, the mounting bracket arrangement is provided with a mounting screw and washer set indicated generally at 74 and a safety chain 75 having a safety chain mounting clip 70 attached at its distal end. The safety chain mounting clip 70 is adapted to be attached to the mounting plate 30 as best seen in FIG. 66 so that during installation of the self contained troffer insert 12, the mounting plate 30 can be supported by the safety chain clip 70 while the system is being coupled to the high voltage wires. After the kit 10 has been installed in the troffer T and coupled to the high voltage service, the safety chain clip 70 may be maintained in place, so should maintenance service every be required on the system 100, the troffer insert 12 may be removed from the support snaps 76 but still be supported by the safety chain 75 and clips 70. In summary then, the retrofit kit 10 may include a mounting arrangement 80 for supporting the mounting plate 30 during installation. To facilitate the use of the mounting arrangement 80 with the mounting plate 30, the mounting plate 30 is provided with a set of safety chain mounting clip holes that are dimensioned to receive therein and retained, the mounting clip 70 as best seen in FIG. 66. The mounting plate 30 is sufficiently flexible to be slightly flexed and snapped into the snap brackets 76 in a friction tight fit. The mounting plate 30 may be flex inwardly to remove it from the snap brackets 76 should the troffer insert 12 be in need of maintenance or repair.

### Illustrative Methods

An illustrative method associated with an exemplary embodiment for a method of assembling and pre-testing a retrofit kit 10 has already been described and will not be further discussed herein.

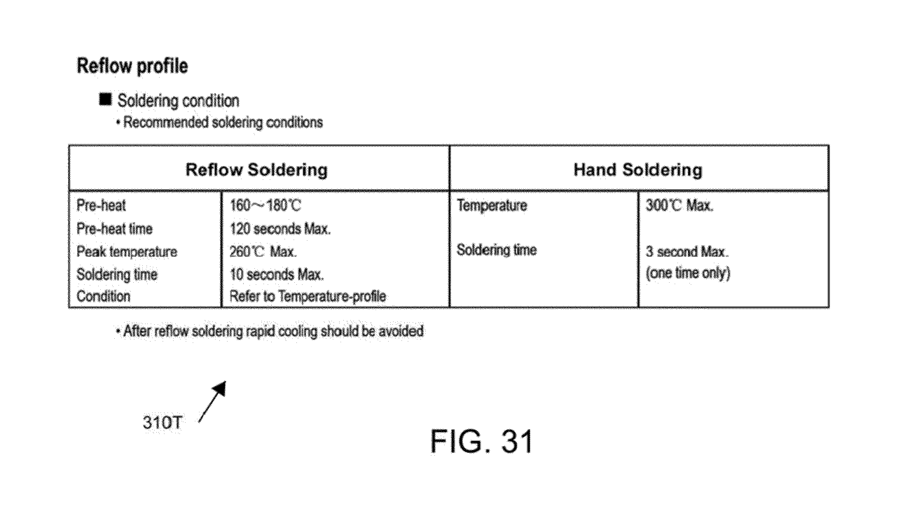

Referring now to the drawings and more particularly to FIGS. 31-34 specification information regarding the soldering of the light emitting diodes to a substrate, such as to a printed circuit board substrate, a face plate of a troffer, or a mounting plate 30 is provided. In this regard, FIG. 31 provides a reflow profile table indicated generally at 310T that provides detailed information for hand soldering and for reflow soldering. In short, table 310T provides the details for the recommended soldering conditions for soldering of the light emitting diodes to a substrate surface, whether that surface is the mounting plate 30, the faceplate of the troffer T, or a diode substrate surface that will be described hereinafter in greater detail.

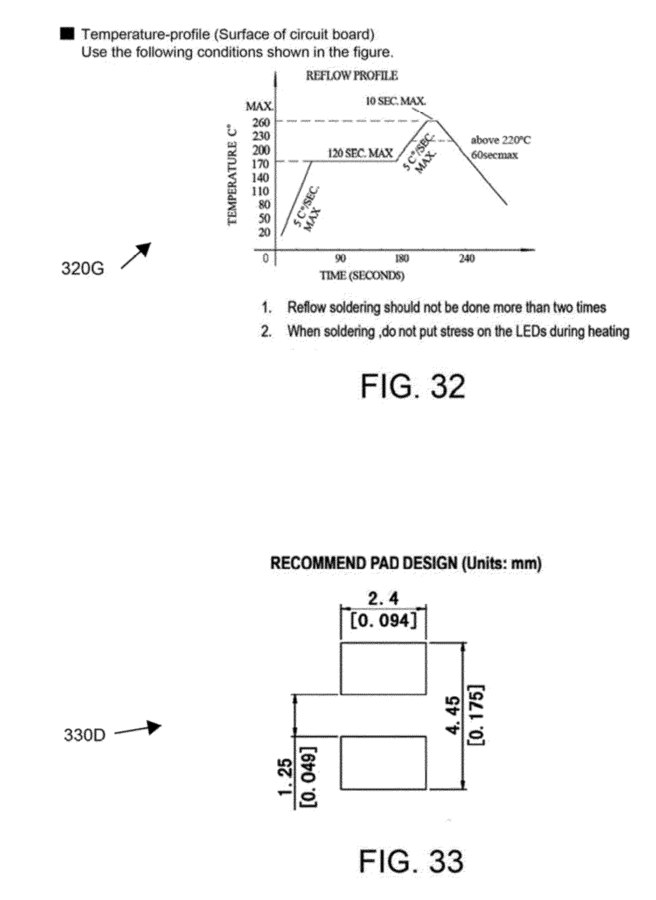

FIG. 32 provides a reflow profile graph 320G with recommended soldering conditions and a graph profile of the surface of a mounting substrate. That is, one should use the conditions shown in FIG. 32 relative to the disclosed temperature profile where it is recommended that (1) reflow soldering should not be done more than two at a time, and (2) that when soldering, one should not put stress on the light emitting diode during the heating process.

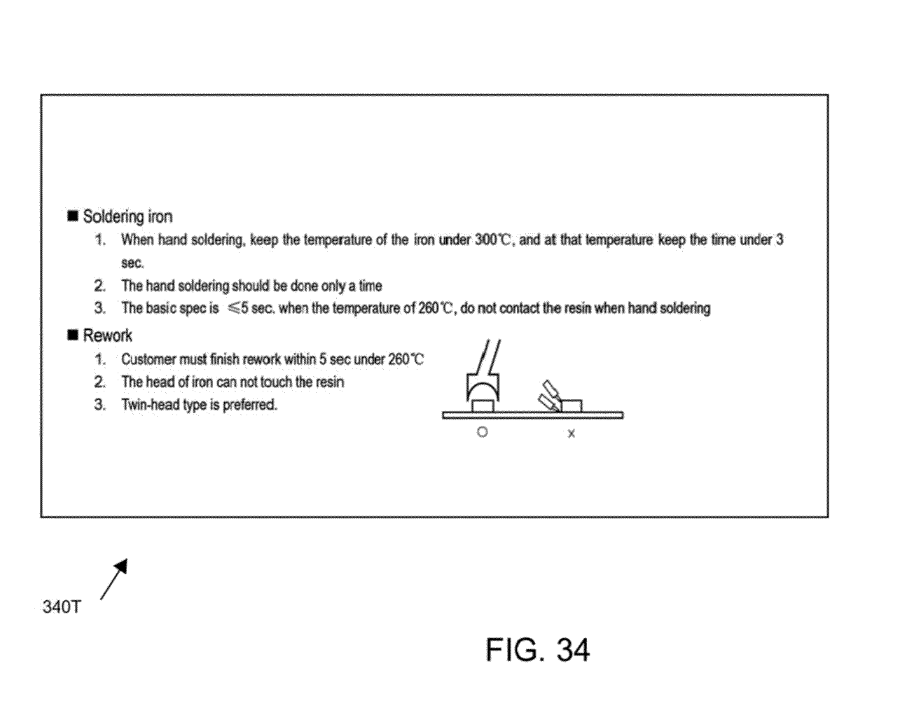

FIG. 33 illustrates a recommended pad design layout 3300, while FIG. 34 provides an information table 340T with information regarding the soldering iron and rework processes. With respect to FIG. 34, relative to the soldering iron, it should be noted that when hand soldering, the temperature of the soldering iron should be maintain at 300 degree centigrade of less at all times, and the actual soldering time at that temperature should be at under three (3) seconds or less. Also the hand soldering should be done only one time, while the basic spec is less than or equal to five (5) seconds when the temperature is 260 degrees centigrade, making certain that the resin is not contacted when hand soldering.

Finally with respect to FIG. 34, when rework is considered, the following should be observed: (1) rework must be completed within five (5) seconds under 260 degrees centigrade; (2) the head of the soldering iron can not touch the resin; and (3) a twin-head type soldering iron is the preferred instrument. In conclusion the, when reviewing FIGS. 31-34 it is highly recommended that certain cautions be carefully followed: That is, since the encapsulated material of the light emitting diode (LED) is silicone, it should be understood by those skilled in the art, that the LEDS have a soft surface on the top of their respective packages. In this regard, the pressure to the top surface will be influence to the reliability of the LEDs. So, when using a picking up nozzle, the pressure on the silicone resin should be proper.

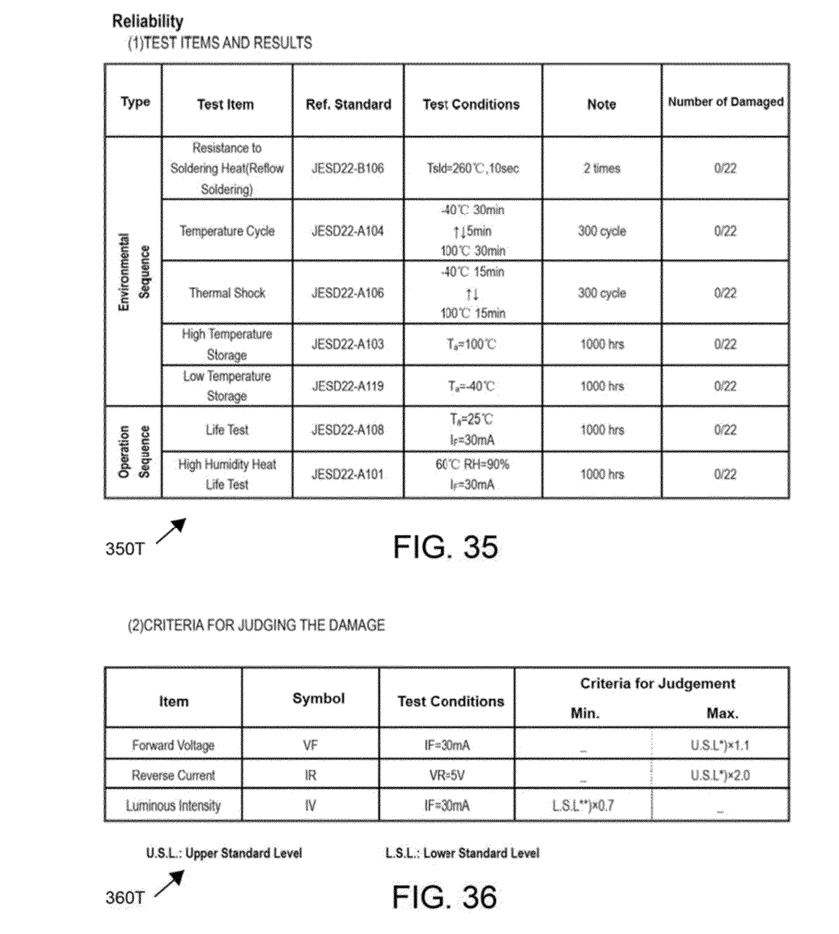

Referring now to the drawings and more particularly to FIGS. 35-36, a reliability table 350T best seen in FIG. 35, provides a list of test items and the results of testing including the number of diodes damaged with reference to the light emitting diodes for use with the mounting plate 30. FIG. 36 provides a criteria table 360T that provides the criteria for judging damage to a light emitting diode, where the abbreviation U.S.L. found in the criteria for judgment disclosure means “upper standard level” and the abbreviation L.S.L found therein means “lower standard level”.

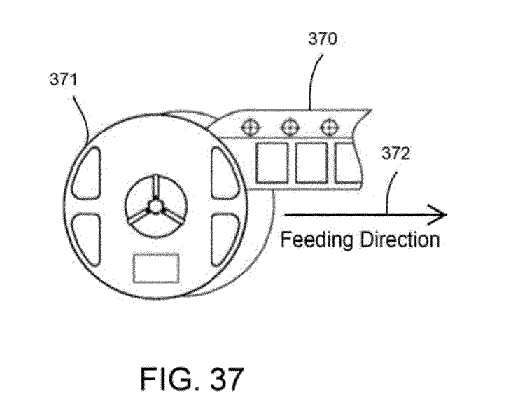

Referring now to the drawings and more particularly to FIGS. 37-43 there is disclosed information regarding the manner in which the light emitting diodes may be provided for the mounting plate 30. In this regard, in FIG. 37 a reel 371 is illustrated loaded with a plurality of the light emitting diodes, such as those depicted in FIGS. 7-9. The light emitting diodes are provided on a flexible tape indicated generally at 370, where a feeding direction 372 for the discharge of individual ones of the diodes from the reel 371 is shown.

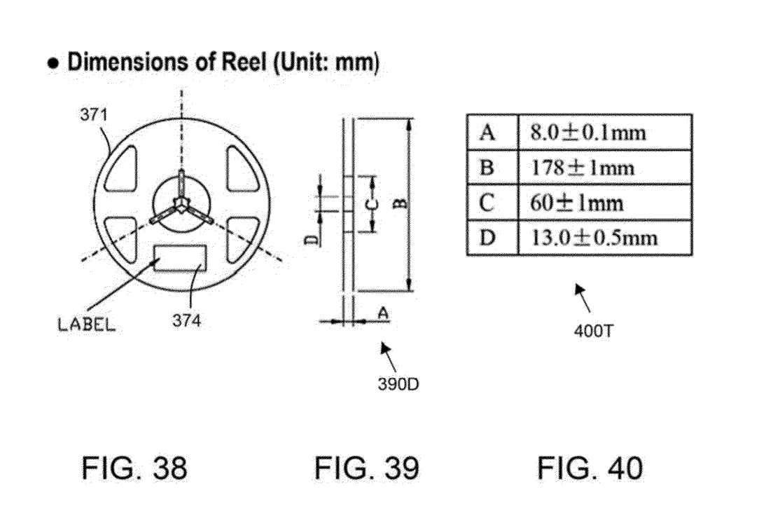

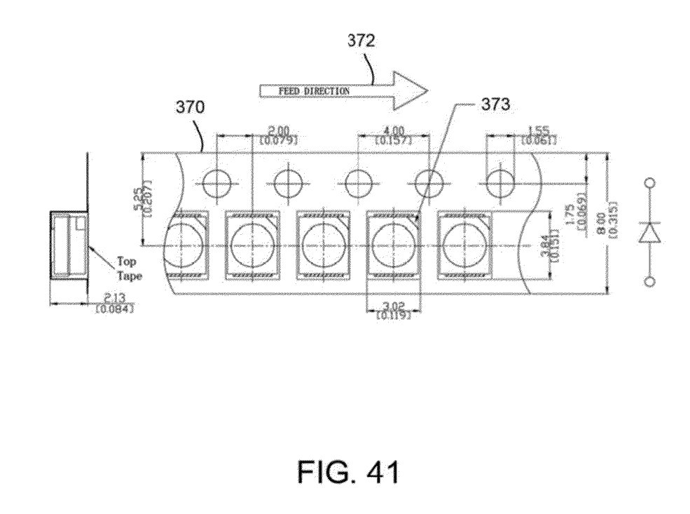

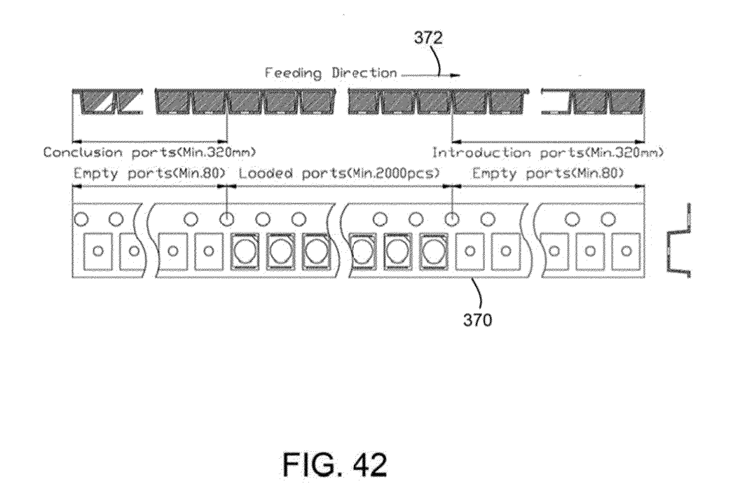

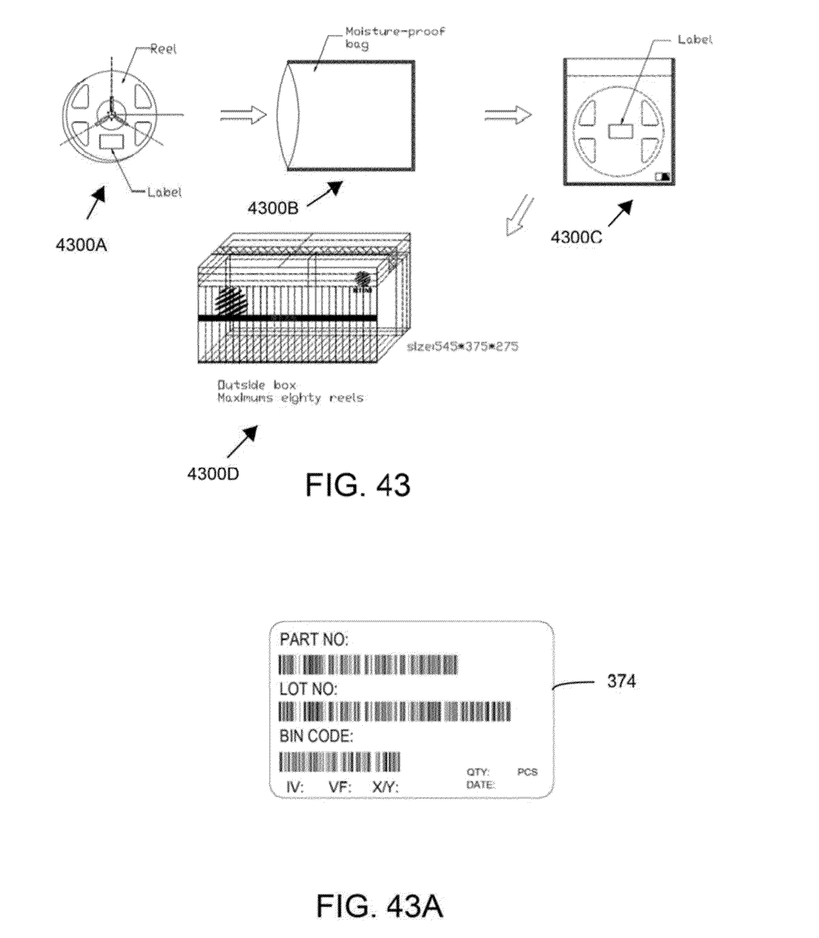

FIGS. 38-43 provide detailed packaging information, arrangement of tape and detailed dimension information regarding the reel 371 illustrated in FIG. 37. In this regard, FIG. 38 is a top plane view of the reel 371 illustrating that it is provided with an identification label, such as the identification label 374 best seen in FIG. 43A. FIGS. 39-40 provided the dimension criteria 390D and the specific dimensions for the criteria are shown in a dimension table 400T best seen in FIG. 40. FIG. 41 is an illustration showing the various dimensions of the reel tape relative to the individual ones of the diodes carried on the tape 370. All dimensions depicted in FIG. 41 are shown in micro millimeters (mm). It should be noted that the polarity of each individual light emitting diode is shown by a polarity mark, indicated generally at 373. These dimensions are important for doing light emitting diode layouts on a mounting plate, such as the mounting plate 30, or for doing diode layouts on the face plate of a troffer or a diode substrate. In this regard, it should be understood by those skilled in the art that layouts may be designed in various configurations ranging from a single diode layout, such as illustrated in FIG. 64 to a plural diode layout as best seen in FIG. 61. In short, there is no intention of limiting the present invention to simple linear, straight line configuration as any geometric configuration (circles, U-shapes, triangular configurations, offset configurations, random arrays, such as star burst arrays, etc) may be configured using individual ones of the diodes on the tape 370. FIG. 42 illustrates the arrangement of the tape 370 illustrated in FIG. 41; and FIG. 43 is a flow chart illustrating the packaging specifications and storage conditions for reeled light emitting diode products, label included, inclusive of the light emitting diode of illustrated in FIGS. 7-9.

There are many different types and kinds of commercial fluorescent light fixtures available to the public. For example, T5 light fixtures, linear fluorescent high bay light fixtures, linear fluorescent vapor proof light fixtures, linear fluorescent troffers, single and double channel linear fluorescent fixtures, linear fluorescent wrap around light fixtures, fluorescent under cabinet light fixtures, surface mount fluorescent strip light fixtures, and recessed fluorescent light fixtures. Such fixtures further utilized many different types and kinds of fluorescent lamps for casting visible radiant energy in at least one direction to render objects in that direction visible, such as tube or compact. The tube type can be circular, U-shaped or linear, while the compact lamps are available as globe, flood lamps, spiral, triple tube and candelabra and are smaller than regular-sized tube fluorescents and are adapted to fit into most conventional lamp sockets. Thus, fluorescent light fixtures with fluorescent bulbs or lamps are utilized for different kinds of lighting purposes including but not limited to interior ambient lighting, exterior ambient lighting, security ambient lighting, warehouse interior ambient lighting, and roadway ambient lighting. The kits and method described herein may be used in a variety of fixture configurations and therefore there is no intention of limiting the use of the kits described herein to only the ceiling mounted shown in FIGS. 55-57 and FIGS. 55A-57A for example. In this regard, the reader is referred to FIGS. 61-64 which illustrate other types of configurations that may employ use of the kits described herein. Examples of other types of linear configuration will follow.

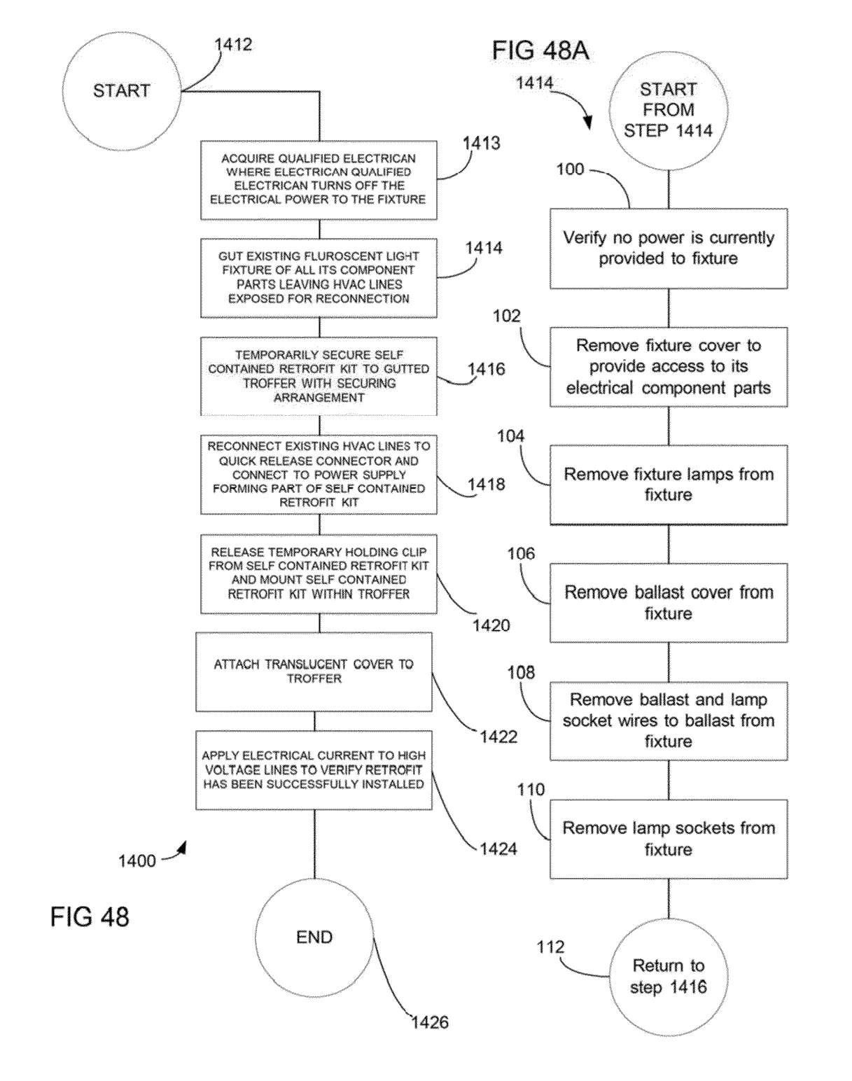

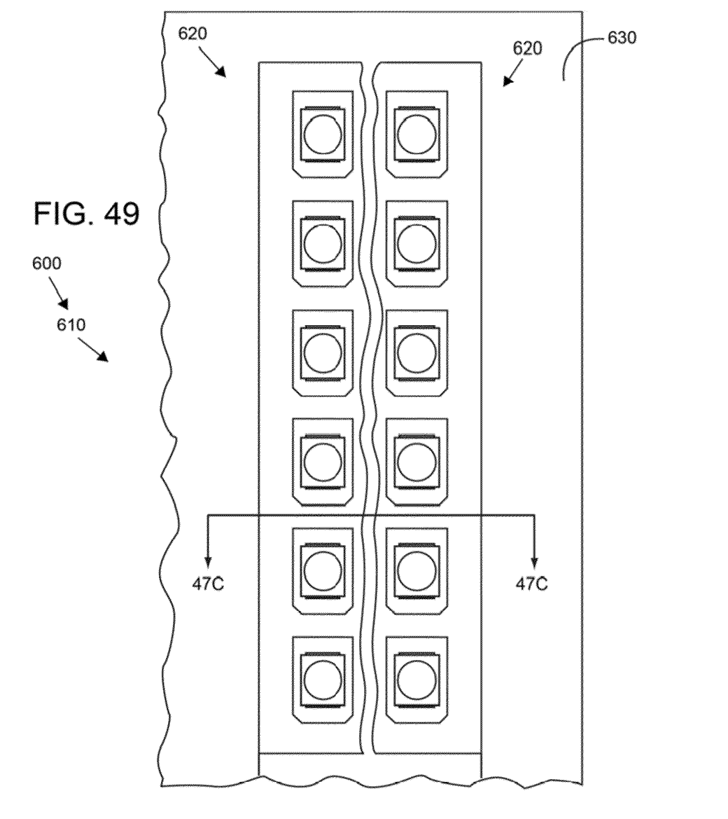

Referring now to the drawings, and more particularly, to FIGS. 48 and 48A, a unique and novel retrofitting method 1400 is illustrated, which retrofitting method 1400 results in a modified light fixture having a replicated luminance pattern substantially the same as the luminance pattern cast by the fluorescent lamp 4 and 5 but with substantially greater luminance due to the effect of retrofitting as will be described hereinafter in greater detail

In order to prepare the light fixture 1 for retrofitting, the light fixture 1 must be substantially gutted by a gutting process indicated generally at a gutting step 1414. The details of this gutting process 1414 are illustrated in FIG. 48A. This gutting process 1414 begins at a start step 1414 and proceeds to at a verifying step 100 where the qualified electrician working on the fixture 1 verifies that the source of universal power supplied to the light fixture 1 has been temporarily turned off either at a junction fuse box switch [not shown] or by simply turning off a wall light switch [not shown], whichever one of these steps is more convenient. After taking this action, further verification can be done simply and quickly by probing the incoming high voltage wires 6, with a voltage meter to verify that no electrical power is being provided at the fixture 1. With the power temporarily turned off, the gutting process continues with a fixture cover removal step 102, where the fixture cover 9TC, if provided with the fixture 1 is removed. When so removed, the fixture cover 9TC may be set aside so that after the retrofitting process 1400 has been completed, the fixture cover 9TC may be replaced if the light fixture 1 was initially provided with such a cover 9TC.

The gutting process then proceeds to a lamp removal step 104, where the fluorescent lamp or lamps 4 and 5 are removed from between the lamp sockets 7 and 8 respectively and then discarded using standard safety discarding procedures set in place for the disposal of fluorescent lamps. Once the lamps 4 and 5 have been removed from the light fixture 1, the gutting process continues to a ballast cover removal step 106, where the ballast cover 9RC is also removed and discarded. Although the ballast cover 9RC is removed and discarded, the mounting hardware, if any, provided for securing the ballast cover 27 to the trough 2, is retained and set aside for use in the retrofitting process 1400 as will be described hereinafter in greater detail.

After the ballast cover 9RC has been removed and disposed of, the gutting process continues with a ballast removal step 108, where the ballast 3 is removed from the fixture 1. In this regard, the wiring from the ballast 3 to the lamp sockets 7 and 9 respectively is disconnected and the wiring 6 from the ballast 3 to the universal source of electrical power is disconnected. With the wiring so removed, the ballast 3 is detached from the trough 2 and discarded using a proper safety disposal procedure for the disposal of such an electrical component.

Next, the gutting process proceeds with an electrical sockets removal step 110, where the electrical sockets 7 and 8 respectively are detached from the trough 2 and discarded using a proper safety disposal procedure for the disposal of such an electrical components. After this removal step 110 has been completed, the light fixture 1 has been completely gutted of its electrical sockets 7 and 8, its wiring, its ballast 3, its ballast cover 9RC and its fixture cover 9TC leaving only the bare empty trough 2 and the exposed incoming universal power wires 6. Mounting hardware for the ballast cover 9RC and the translucent cover 9TC, if provided, is not removed. In this regard, this mounting hardware may be utilized to mount the troffer insert 12 instead of using the optional mounting hardware 80. The gutted fixture 1 is now ready for an upgrade using a retrofit kit, such as a retrofit kit 10 as previously described or any of the other retrofit kits described herein, such as for example retrofit kit 100. It is suffice to say that the retrofit process 1400 is applied via a return step 112 that returns the process to the temporary secure step 1416 as previously described herein.

Printed Circuit Board Substrate Troffer Insert, with One or More Modular LED Boards with Concealed Power Supply Converter

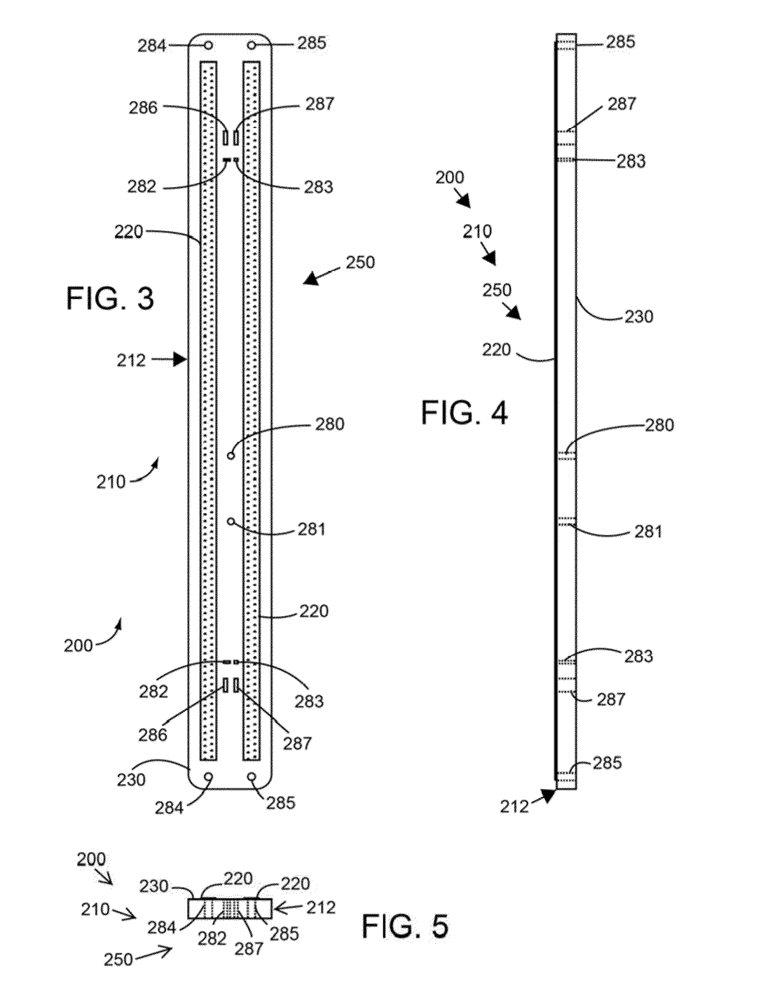

Referring now to the drawings and more particularly to FIGS. 3-5, there is shown a second embodiment self contained fluorescent light fixture retrofit kit 210, which is constructed in accordance with the present invention. The self contained retrofit kit 210, when installed in a gutted troffer T, provides a new and improved lighting system 200 which provides several unique advantages. Firstly, the kit 210 provides a self contained illumination assembly or troffer insert 212 that can be easily and quickly installed in the gutted fluorescent light fixture T. Secondly, the self contained illumination assembly 212 cast visible radiant energy in at least one direction to render object in that direction visible, where the source of the visible radiant energy may be easily and quickly clustered to provide increased light output. Thirdly, the self contained illumination assembly 212 in at least one embodiment provides a substantially flat reflective surface which casts no shadows thereby providing an aesthetically pleasing ambient light setting. Fourthly, installation of the kit 210 eliminates the need for long wire strings, thus greatly reducing the amount of copper needed, which in turn reduces the cost for the kit 210. Finally, the kit 210 is universal, and modular in nature so that when installed in the gutted light fixture, the kit 210 provides a light pattern that is substantially the same pattern as previously produced by the light fixture, whether the fixture provided a light source which is virtually a single straight line having a dimension substantially greater in one direction than any in a plane transverse to said dimension; or plural light sources virtually in single straight lines each having a dimension substantially greater in one direction than any in a plane transverse to said dimension; or specially configured light sources configured in circular or U-shaped patterns, staggered and offset patterns or even configured as a single point light source pattern.

Considering now the fluorescent light fixture retrofit kit 210 in greater detail, the retrofit kit 210, generally includes: 1) a self contained illumination assembly 212 which is configured as a replacement unit for the ballast cover 9RC removed from the gutted fluorescent light fixture and 2) an optional set of mounting hardware, indicated generally at 78 and 80 (FIG. 66) for electrically coupling the self contained illumination assembly 212 to the universal source of power and for mechanically securing the self contained illumination assembly 212 into the gutted fixture T.

As best seen in FIGS. 3-5, the self contained illumination assembly 212 is totally self contained and includes: 1) a combination power supply with an AC/DC converter 250 (which is substantially the same as the converter 50 as previously described herein) for providing a source of constant power in the form of constant current or constant voltage; 2) a flexible, substantially flat, printed circuit board substrate 230 that will snap fit into the troffer T in place and stead of the raceway cover 9RC; and 3) at least one string of light emitting diodes (each string being mounted on a modular LED printed circuit board, indicted generally at 220). The individual light emitting diodes in each string transform the constant power provided by the converter 250 into visible radiant energy cast in at least one direction to render objects in that direction visible. The substrate or mounting plate 230 may be coated with a reflective paint or other suitable reflective coating for helping to reflectively cast the visible radiant energy in a plurality of different directions. The kit 210 may further include a set of high voltage connectors, such as those indicated generally at 78 in FIG. 66 for coupling the converter 250 to a universal source of power provided by the high voltage wires previously installed in the gutted fixture. In this regard, the universal source of power may be a 120V, 60 Hz source or a 220 to 240 V, 50 Hz source. Other universal sources of power may also be employed for example 85 VAC to 305 VAC at 50/60 Hz or even 480 VAC at 60 Hz.

The lower voltage output from the power supply converter 250 may be directly coupled to a diode string 220 (see FIG. 55 for a direct wire 531 type of connection) or in the alternative, as best seen in FIG. 54 the low voltage service may be electrically and mechanically coupled between a pair of the LED modular boards 220, by a jumper board, such as a jumper board JTP for supplying them as well as the other light emitting diodes in the self contained illumination assembly 212 with a source of constant direct current. For keeping the diagrammatic representation of the kit 210 and resulting light system simple, the wiring, jumper boards and power converter are not shown in FIGS. 3-5. However, those skilled in the art, by referring to other figures in this disclosure, such as FIGS. 2 and 54 for example, will clearly understand how this electrical service is provided.

The retrofit kit 210 as mentioned is self contained which in the simplest terms means that since the gutted troffer T was provided with a raceway cover 9RC, a qualified electrician installing the kit 210 into a gutted troffer T would only need to temporarily support the substrate 230 within the troffer T while the set of high voltage connectors 78 are connected to the universal source of power provided through the high voltages wires 6. Once this electrical coupling is made, the electrician would then simple install the substrate 230 within the troffer T using the mounting hardware that was used for supporting the raceway cover 9RC. In this regard, the mounting plate 230 serves to conceal from view, the high voltage wires, the set of high voltage connectors 78, and the power converter 250, which are disposed behind the substrate 230 when it is mounted within the troffer T.

In an alternative configuration, the power supply converter 250, like power supply 50, may be provided with a push wire connector system 52 (FIG. 13) as opposed to the wire nuts indicated generally at 78. In this regard, the female connector 56 of the push wire connector system 52 as provided is pre connected to the male connector 54, which in turn is directly coupled to the power supply 250. Installation of the push wire connector system 52 therefore only requires that the positive and negative wires from the high voltage service 6, be pushed into their respective mounts in the daisy chain feature 58 of the push wire connector system 52. It should be understood by those skilled in the art, that this process of connecting wires to the connector system 52, could be easily and quickly accomplished without the need of temporarily supporting the self contained assembly 212 within the troffer T. Final installation of the retrofit kit 210, after coupling the high voltage service 6 to the push wire connector system 52, would therefor only require that the substrate 230 to be installed in the troffer T either using the hardware previously provided for the raceway cover 9RC or by using the optional mounting hardware 80 provided in the retrofit kit 210, if needed.

Considering the insert 212 in still greater detail, In this preferred embodiment, the kit 210, unlike kit 10, includes modular diode boards, such as a modular diode string 220 which is adapted to be mounted to a printed circuit board substrate 230. The substrate 230 may, in turn, be mounted directly to a flat surface area of a mounting plate, such as the mounting plate 30 as best seen in FIG. 2. In the alternative the substrate 230 may be mounted directly to the face plate of the troffer T, such as the face plate 14 (FIG. 2). In either configuration, the modular diode boards 220 mounted on substrate 230 are adapted to be electrically coupled to either another modular diode board or to the direct current power supply 250 by the push wire connector system, such as the push wire connector system 52.

Considering now the substrate 230 in greater detail with reference to FIGS. 3-5, the substrate 230 in the preferred embodiment is slightly flexible so it may be flexed and snap fit or positioned into a set of troffer snap supports, such as a snap support 76 and supported from below by a mounting bracket arrangement 72 as best seen in FIG. 65. The substrate 230 due to its elongate configuration is configured in a slight U-shape to provide the substrate 330 with greater strength and rigidity. In order to facilitate removably securing the substrate 230 to a mounting bracket arrangement, such as the mounting bracket arrangement 72, the substrate 230 is provided with a set of bracket mounting holes indicated at 286 and 287. To facilitate holding the substrate 230 within a troffer T in a safe and secure manner, the substrate 230 is provided with a set of safety chain clip mounting holes indicated generally at 282 and 283 respectively. The substrate 230 is also provided with a set of power supply mounting holes or apertures indicated generally at 280 and 281, so the power supply 250 may be mounted to either the underside of the substrate, where it would be concealed from view and would not act as a shadow casting object relative to the light emitting diodes 230 on the top surface of the substrate 230. Although in this preferred embodiment, the substrate 230 is described as being supported from below by the mounting arrangement 72, in an alternative embodiment, the substrate 230 may be sufficiently thick so that it may be mounted to a mounting plate or to the face plate of the troffer T. In this regard, the substrate 230 is provided with a set of mounting holes or apertures indicated generally at 284 and 285 respectively.

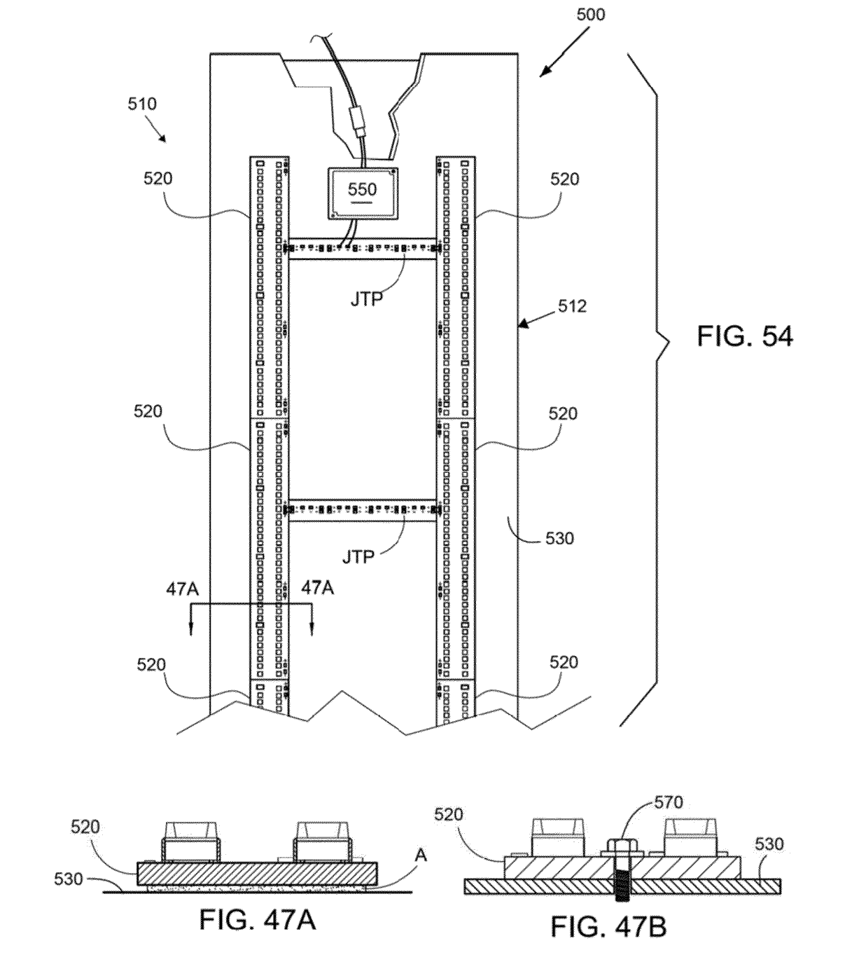

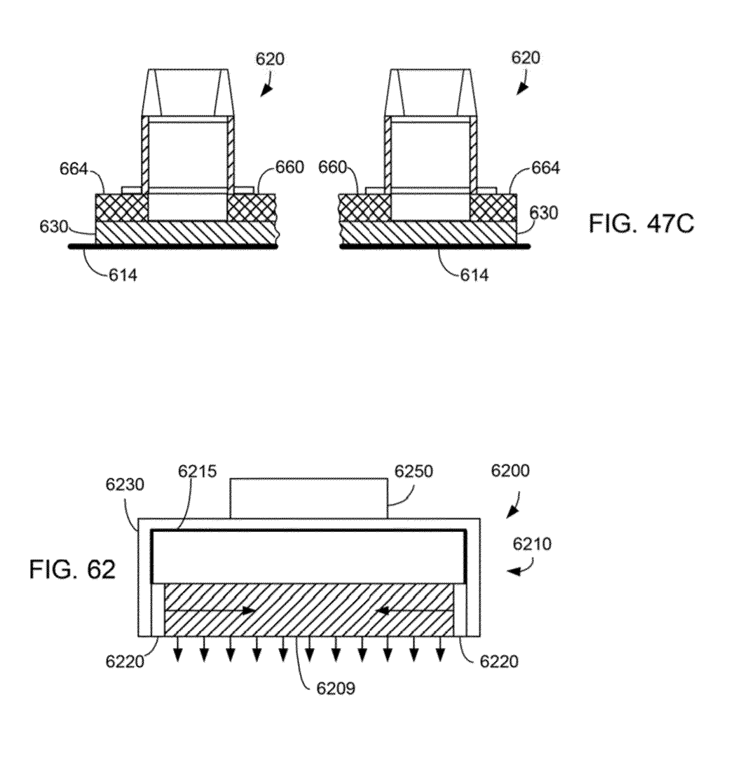

Considering now the modular diode board 220 in greater detail, the modular diode board 220 generally a printed circuit board substrate having mounted thereto one or more light emitting diodes. The diode board substrate is so sufficiently thin it may be rolled up and shipped in kit strips with N number of diodes. To facilitate the securing of the diode board 220 to the substrate 230, the reverse side of the diode board 220 is provided with a double sided very high bonding (VHB) tape, one side secured to the board and the opposite side of the VHB tape being provided with a peel off protective cover (not shown). In this manner, the diode board 220 may be first unrolled from the kit 210; then denuded of its protective cover, and then adhesively secured to the substrate 230. From the foregoing, it should be understood by those skilled in the art, that the diode board 220 provided in a kit may contain as few as a single light emitting diode, or as many as N number of light emitting diodes necessary to satisfy any desired lighting condition. Although the diode board 220 has been described as being sufficiently thin to allow it to be rolled up, it is contemplated that in certain applications adhesive bonding of the diode board 220 to a substrate may not be desired because of environmental condition. For example, it may be too cold, too hot, or to humid for adhesive use. In this regard, it is contemplated that the diode board 220 may be constructed of conventional printed circuit board material of a sufficient thickness to permit the diode board 220 to be screw mounted to the substrate 230 by mounting hardware, such as a mounting screw 570 as best seen in FIG. 47B. In these alternative embodiments, the diode board may be constructed of a metallic material, such as aluminum and coated with a printed circuit board material with light emitting diodes electrical and mechanically coupled to the printed circuit board. As such printed circuit board arrangements are well known in the industry, they will not be described hereinafter in greater detail. The thin configuration of a tape that can be rolled up however, will be discussed hereinafter in greater detail with reference to FIGS. 37-43.

Printed Circuit Board Substrate and One or More Modular LED Boards Troffer Face Plate Insert with Visible Power Supply Converter

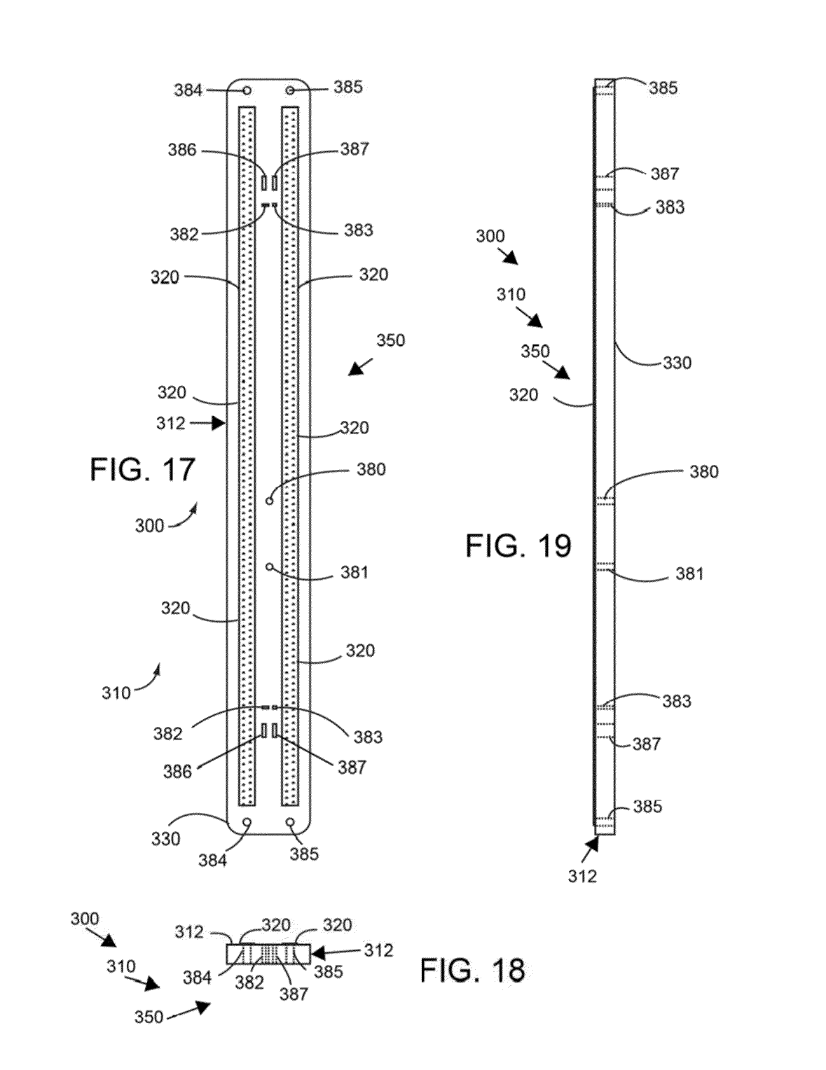

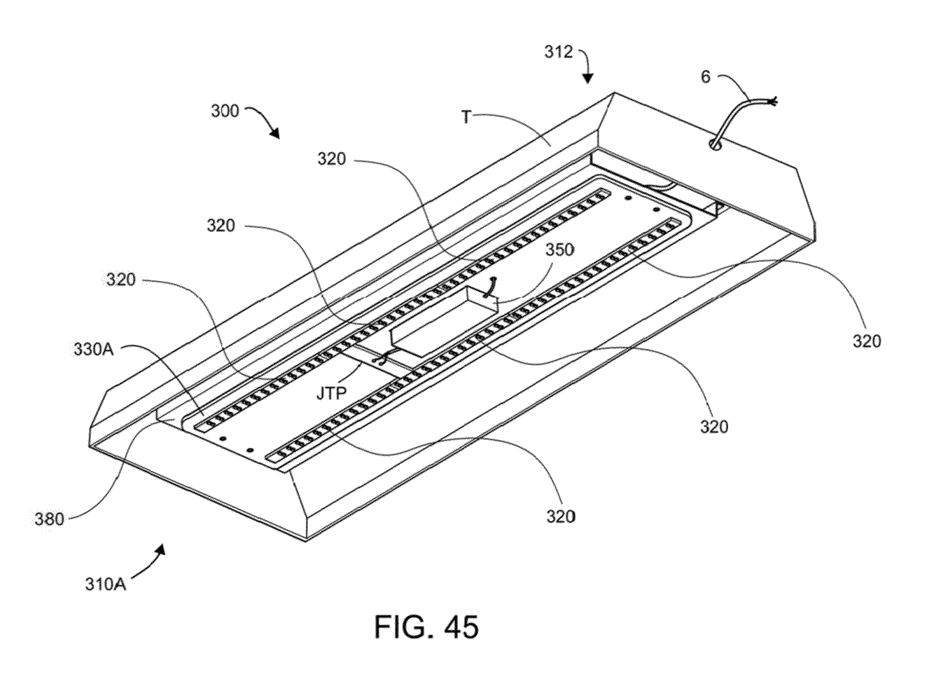

Referring now to the drawings and more particularly to FIGS. 17-19 and 45, there is shown a third embodiment self contained retrofit kit 310 and lighting system 300, which kit 310 and lighting system 300 are constructed in accordance with the present invention. The retrofit kit 310 and lighting system 300 are substantially similar to kit 210 and lighting system 200 except that retrofit kit 310 includes a self contain troffer insert 312, where the power supply converter 350 is mounted to the face plate 14 or to the top surface of the substrate 330 as opposed to its undersurface as was the case illustrated with the troffer insert 212. Moreover, the substrate 330 is secured to the top surface of a mounting plate, such as a mounting plate 380 as best seen in FIG. 45. In this preferred embodiment, the substrate 330 has mounted thereto a plurality of light emitting diode boards, each individual board being indicated generally at 320. A kit 310A as illustrated in FIG. 45 depicts a modified substrate 330A where sufficient space is provided between diode strings to allow for the mounting of the power supply converter 350, where the substrate 330A is secured to a mounting plate 380 as opposed to the face plate of the troffer.

It should be understood however, by those skilled in the art, due to the modular nature of the kits described herein, various configurations are entirely possible. For example, a mounting plate could be provided with a plurality of substrates or even with a plurality of light emitting diode strings. For example, in FIG. 55 a mounting plate 530 is shown with a single light emitting diode string, while FIGS. 56-57 illustrate mounting plates 630 and 730 respectively, where these mounting plates have mounted thereto pluralities of light emitting diode strings. In still yet other configurations, the diode strings, may be mounted directly to the troffer. For example as best seen in FIG. 55A, a single diode string 520 is shown mounted to the face of the troffer T, while FIGS. 56A-57A illustrate troffer face plates with pluralities of diode strings mounted thereto. In this regard, FIG. 56A illustrates a set 620 of at least three diode strings, while FIG. 57A illustrates a set 720 of at least six diode strings. Based on the foregoing, there is no intention of limiting the configurations to those explained in detail herein as other configuration are contemplated within the true spirit and scope of this disclosure.

Considering now the substrate 330 in still greater detail, the substrate 330 has a sufficient longitudinal length and width to receive thereon and to support therefrom a plurality of printed circuit boards or diode strings, such as the printed circuit board 320. In this example, the retrofit kit 310 includes six (6) identical printed circuit boards, such as a printed circuit board 320. Each printed circuit board 320 is constructed and tested in substantially the same manner as previously discussed relative to printed circuit board 20 and the associated LED clusters 32 mounted on such a board 20. Accordingly, there will be no further description provided for the printed circuit board 320 except to mention that the printed circuit substrate 330 with a set of modular boards mounted thereon, such as the modular boards 320 is adapted to be mounted to the flat planar surface of a mounting plate 380 as best seen in FIG. 45. In order to couple the printed circuit board or diode string combination mounted on the upper surface of the substrate 330A, with the direct current from the power supply 350, the substrate 330 is provided with a set of wire communication holes or apertures such as those in FIGS. 17-19 indicated generally at 384 and 385 respectively.

The retrofit kit 310 and lighting system 300 are substantially similar to the retrofit kit 210 and lighting system 200 except that retrofit kit 310 includes a 600 LED configuration as opposed to the 420 LED configuration found in kit 210. In this regard, the retrofit 310 includes a set of 6 identical printed circuit boards 320, mounted to the substrate 330. Each board 320 has mounted thereon 100 LEDs. As this configuration is substantially similar to that previously described, the printed circuit board 320 will not be described hereinafter in greater detail.

Considering now the kit 310, the substrate 330 is a thin sheet of non conductive material that is adapted to receive thereon one or more string of light emitting diodes in the form of modular light emitting diode printed circuit boards indicated at 320. The substrate 330 is provided with safety chain clip holes and power supply mounting holes at 382-383 so that a power supply converter, such as the power supply converter 350 may be mounted to the underside of the substrate. The substrate 330 is further provided with a set of safety chain clip mounting holes 386-387 respectively, which holes are similar to those described with reference to substrate 230.

The substrate 330 may be mounted in the same manner as substrate 230, so that it may be supported from below by the mounting arrangement 72 and snap supports 76, or it may be directly mounted to a faceplate of a troffer T. When using the mounting arrangement 72, the substrate 330 if positioned into a snap support 76 on either the left side or the right side of the troffer T, flexed and then lowered into a snap support 76 on the opposite side so that the substrate 330 is now supported within the snap supports 76. The substrate 330 is then pushed downwardly so the mounting brackets 72A extend through a set of mounting bracket holes 386-387 and snap fit within the holes, thereby supporting the substrate 330 from below. In the alternative embodiment, the substrate 330 is provided with faceplate mounting holes 384-385 respectively so the substrate 330 may be screw mounted to the faceplate of the troffer T.

Troffer Insert with Modular LED Boards and Visible Power Supply Converter

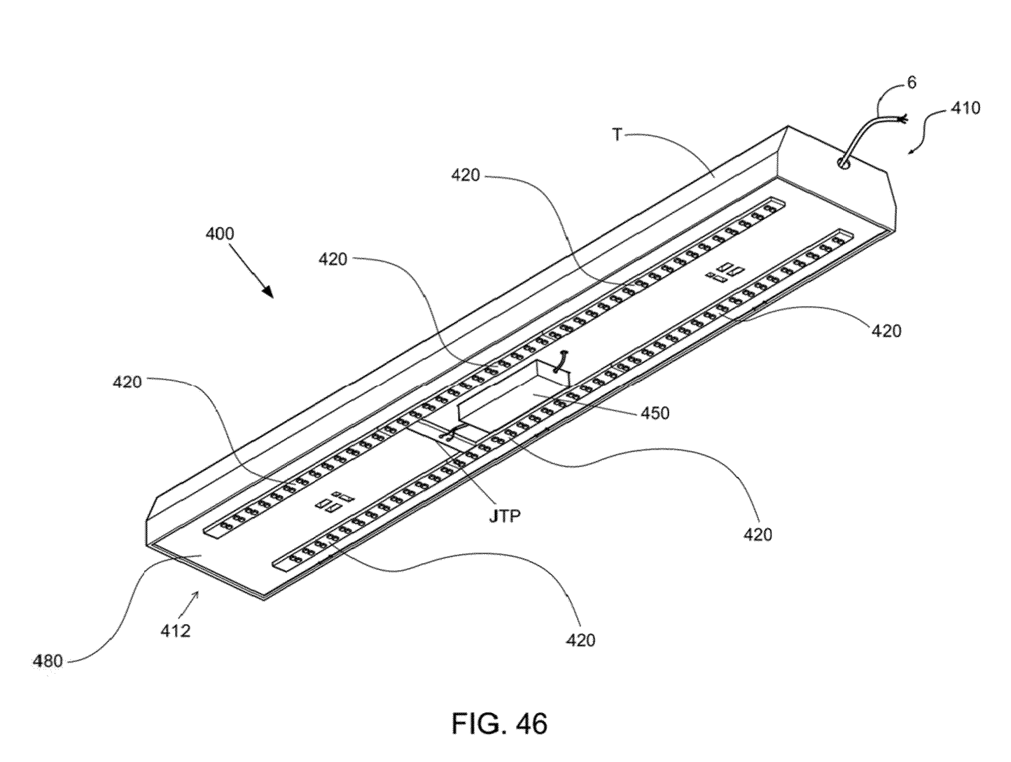

Referring now to the drawings and more particularly to FIG. 46, there is shown a fourth embodiment self contained retrofit kit 410 and lighting system 400, which kit 410 and lighting system 400 are constructed in accordance with the present invention. The retrofit kit 410 and lighting system 400 are substantially similar to kit 10 and lighting system 100 except that retrofit kit 410 includes a self contain troffer insert 412, where a power supply converter 450 is mounted to the top surface of a mounting plate 480 as opposed to its undersurface as was the case illustrated with the troffer insert 12.

The troffer insert 412 includes the mounting plate 480, a plurality of printed circuit boards, such as the printed circuit board 420, and a power supply converter 450 which is substantially similar to the power supply converter 50 previously described. The retrofit kit 410 also includes optional mounting hardware, such as the optional mounting hardware 80 previously described. In this regard, there will be no further description provided herein relative to the power supply converter 450 or the optional mounting hardware 80.

Considering now the mounting plate 480 in greater detail with reference to FIG. 46, the mounting plate 480 has a sufficient longitudinal length and width to receive thereon and to support therefrom the plurality of printed circuit boards or diode strings, such as the printed circuit board 420. The mounting plate 480 is adapted to be supported in the troffer T using the existing troffer hardware construction that supported the gutted raceway cover, such as a gutted raceway cover 9RC as described previously relative to the light fixture 1. In this present example, the retrofit kit 410, like retrofit kit 310 includes six (6) identical LED printed circuit boards, such as the LED printed circuit board 420. Each printed circuit board 420 is constructed and tested in substantially the same manner as previously discussed relative to printed circuit board 20 and the associated LED clusters 32 mounted on such a board 20. Accordingly, there will be no further description provided for the printed circuit board. In order to couple the printed circuit board or diode string combination mounted on the upper surface of the substrate 480, with the direct current from the power supply 450, the substrate 480 has mounted thereto a jumper board JTP. The jumper board JTP is connected to the low voltage output of the power supply converter 450 so that electrical power from the power supply converter 450 may be supplied to a pair of printed circuit boards 420. In this regard, the jumper board JTP is coupled between a pair of the printed circuit boards 420.

Mounting Plate Troffer Insert with Partially Visible Power Supply Converter

Referring now to the drawings and more particularly to FIG. 54, there is shown a fifth embodiment of a self contained retrofit kit 510 and lighting system 500, which kit 510 and lighting system 500 are constructed in accordance with the present invention. The retrofit kit 510 and lighting system 500 are substantially similar to kit 10 and lighting system 100 except that retrofit kit 510 includes a self contain troffer insert 512, where a power supply converter 550 is mounted within the mounting plate 530 as opposed to its undersurface as was the case illustrated with the troffer insert 12 or to its upper or top surface as was the case illustrated with the troffer insert 512. In order to mount the power supply converter 550 in this manner, the troffer insert 512 is provided with a power supply mounting bracket, such as a mounting bracket 5840 (FIG. 58). This power supply mounting arrangement permit the quick and easy replacement or servicing of the power supply converter 550.

The troffer insert 512 includes the mounting plate 530, a plurality of modular LED printed circuit boards, such as the printed circuit board 520, and a power supply converter 550 which is substantially similar to the power supply converter 50 previously described. The retrofit kit 510 also includes optional mounting hardware, such as the optional mounting hardware 80 previously described. In this regard, there will be no further description provided herein relative to the power supply converter 550 or the optional mounting hardware 80.

Considering now the printed circuit boards 520 in greater detail with reference to FIGS. 47A and 54, the mounting plate 530 has a sufficient longitudinal length and width to receive thereon and to support therefrom the plurality of printed circuit boards or diode strings, such as the printed circuit board 520. The mounting plate 530 is adapted to be supported in the troffer T using the existing troffer hardware construction that supported the gutted raceway cover, such as a gutted raceway cover 9RC as described previously relative to the light fixture 1. In this present example, the retrofit kit 510, like retrofit kit 510 includes six (6) identical printed circuit boards, such as the printed circuit board 520. Each printed circuit board 520 is constructed and tested in substantially the same manner as previously discussed relative to printed circuit board 20 and the associated LED clusters 32 mounted on such a board 20. Accordingly, there will be no further description provided for the printed circuit board 520 except to mention the manner in which the printed circuit boards 520 are mounted to the mounting plate 530. In this regard, as best seen in FIG. 47A, the printed circuit board 520 is mounted to the mounting plate 530 by an appropriate adhesive, indicated generally at A. As an alternative method of mounting the printed circuit board 520 to the mounting plate 530, mounting hardware 570 (FIG. 47B) may be utilized instead of the adhesive method.

Other modifications and implementations will occur to those skilled in the art without departing from the spirit and the scope of the invention as claimed. For example, the retrofit kit and lighting system may be used with a variety of fixed housing structures including those recessed within a ceiling, those hanging from a ceiling structure, and those requiring weather proof seals to allow use in outdoor structures. For example, the retrofit kit and lighting system may be used within commercial building, residential structures, stairways, and parking structures. Also, different types of printed circuit board configuration would be possible utilizing the same matching concepts. For example the printed circuit boards discussed in U.S. patent application Ser. No. 12/386,545 entitled, “Adjustable LED Lighting System, Kit and Method of Using Same,” by Jack Dubord, filed Apr. 20, 2009, and U.S. patent application Ser. No. 12/261,754, Entitled “Adjustable Modular Lighting System and Method of Using Same,” by Jack Dubord, filed Oct. 30, 2008 would be suitable substitutions. Moreover, using a matching technique, LEDs with a predetermined voltage drop of say between 2.5V and 3.0V could be selected and use for only a 2.5V to 3.0V printed circuit board. Similarly, LEDs with a predetermined voltage drop of say between 3.0V and 3.1V could be used exclusively for another type of printed circuit board. In this manner selecting different preferred voltage drops specially selected printed board could be precisely matched with a give type of constant current power supply to achieve desired results. It should be understood by those skilled in the art, that a constant current power supply converter is more efficient, but the light emitting diode arrays energized by this source need to be balances to the current. Both 12 VDC and 24 VDC low voltage sources may be utilized.

### Examples of Modifications to Configurations and Embodiments

Referring to FIG. 58 as a first example there is illustrated a lighting system 5800 and retrofit kit 5810, which kit and system are constructed in accordance with the present invention. The retrofit kit 5810 generally includes a self contained troffer insert 5812 which is adapted to be supported within a gutted troffer, such as the gutted troffer T. The troffer insert 5812 includes a set of printed circuit boards indicated individually generally at 5820, where each printed circuit board has disposed thereon a plurality of light emitting diodes. The printed circuit boards 5820 are mechanically mounted to a mounting plate 5830 which is adapted to be supported within a gutted troffer, such as the gutted troffer T. The mounting plate 5830 includes a cutout area for receiving therein a power supply converter, such as the power supply converter 5850. The power supply converter 5850 is held within the cutout area by a mounting bracket 5840 so that is disposed both above and below the mounting plate 5830. The power supply converter 5850 is electrically coupled to the printed circuit boards 5820 so the individual light emitting diodes disposed thereon may be energized for emitting light energy. As these various components are substantially similar to those that have been described herein with reference to other kits, the various component mentioned will not be described in greater detail.

Referring to FIG. 59 there is another example illustrated in a lighting system 5900 and retrofit kit 5910, which kit and system are constructed in accordance with the present invention. The retrofit kit 5910 generally includes a self contained troffer insert 5912 which may be quickly and easily installed in a gutted troffer, like the troffer T. The kit 5912 includes a set of printed circuit boards indicated individually generally at 5920, where each printed circuit board has disposed thereon a plurality of light emitting diodes. The printed circuit boards 5920 are mechanically mounted to a mounting plate 5930 which is adapted to be supported within the gutted troffer, such as the gutted troffer T. The mounting plate 5930 supports from below a power supply converter 5950, which is mounted to the underside of the mounting plate 5930. The power supply converter 5950 is electrically coupled to the printed circuit boards 5920 so the individual light emitting diodes disposed thereon may be energized for emitting light energy. As these various components are substantially similar to those that have been described herein with reference to other kits, the various component mentioned will not be described in greater detail.

Referring to FIG. 59A there is yet another example illustrated in a lighting system 5900A and retrofit kit 5810A, which kit and system are constructed in accordance with the present invention. The retrofit kit 5910A generally includes a self contained troffer insert 5912A which may be quickly and easily installed in a gutted troffer, like the troffer T. The kit 5912A includes a set of printed circuit boards indicated individually generally at 5920A, where each printed circuit board has disposed thereon a plurality of light emitting diodes. The printed circuit boards 5920A are mechanically mounted to a mounting plate 5930A which is adapted to be supported within the gutted troffer, such as the gutted troffer T. The mounting plate 5930A supports from above a power supply converter 5950A, which is mounted to the top or upper viewed side of the mounting plate 5930A. The power supply converter 5950 is electrically coupled to the printed circuit boards 5920 so the individual light emitting diodes disposed thereon may be energized for emitting light energy. To provide the lighting system 5900A with a more aesthetic appearance the kit 5912A is further provided with a power supply cover indicated generally at 5960. As these various components are substantially similar to those that have been described herein with reference to other kits, the various component mentioned will not be described in greater detail.

Referring to FIG. 60, as another example, there is illustrated a lighting system 6000 and retrofit kit 6010, which kit and system are constructed in accordance with the present invention. The retrofit kit 6010 generally includes a self contained troffer insert 6012 which may be quickly and easily installed in a gutted troffer, like the troffer T. The kit 6012 includes a set of printed circuit boards indicated individually generally at 6020, where each printed circuit board has disposed thereon a plurality of light emitting diodes. The printed circuit boards 6020 are mechanically mounted to a substrate or a mounting plate 6030 which is adapted to be supported within the gutted troffer, such as the gutted troffer T. The mounting plate 6030 supports from below a pair of power supply converters each indicated individually at 6050, which converters 6050 are mounted to underside of the mounting plate 6030 and are concealed from view. Each power supply converter 6050 is adapted to energize a single printed circuit board, such as the printed circuit board 6020. In this manner, the individual diode strings may be separately electrically energize as opposed to having all the diode strings energized at once. As these various components are substantially similar to those that have been described herein with reference to other kits, the various component mentioned will not be described in greater detail.

Referring to FIG. 61 there is another example illustrated in a lighting system 6100 and retrofit kit 6110, which kit and system are constructed in accordance with the present invention. The retrofit kit 6110 generally includes a self contained troffer insert 6112 which may be quickly and easily installed in a gutted troffer, like the troffer T. The kit 6112 includes a set of printed circuit boards indicated individually generally at 6120, where each printed circuit board has disposed thereon a plurality of light emitting diodes. The printed circuit boards 6120 are mechanically mounted to an angular mounting plate 6130 which is adapted to be supported within the gutted troffer, such as the gutted troffer T, by means not shown. The angular construction of the mounting plate 6130 permits the light energy generated from the individual light emitting diodes to be reflected off of a reflective surface of the troffer T, such as the reflective surface indicated generally at 6115. The mounting plate 6130 includes a cutout area for receiving therein a power supply converter, such as the power supply converter 6150. The power supply converter 6150 is held within the cutout area by a mounting bracket 6140 so that is disposed both above and below the mounting plate 6130. The power supply converter 6150 is electrically coupled to the printed circuit boards 6120 so the individual light emitting diodes disposed thereon may be energized for emitting light energy. As these various components are substantially similar to those that have been described herein with reference to other kits, the various component mentioned will not be described in greater detail.

Referring to FIG. 62 there is still yet another example illustrated in a lighting system 6200 and retrofit kit 6210, which kit and system are constructed in accordance with the present invention. The retrofit kit 6210 generally includes a self contained troffer insert 6212 which may be quickly and easily installed in a gutted troffer (not shown). The kit 6212 includes a set of printed circuit boards indicated individually generally at 6220, where each printed circuit board has disposed thereon a plurality of light emitting diodes. The printed circuit boards 6220 are mechanically mounted to an angular mounting plate 6230 which is adapted to be supported within the gutted troffer, by means not shown. The angular construction of the mounting plate 6230 permits the light energy generated from the individual light emitting diodes to be directed laterally along a sheet, panel or plate indicated generally at 6209. The panel or sheet 6209 is composed of a highly transparent resin such as preferred poly(methyl methacrylate) (PMMA), or other resins such as polycarbonate (PC) or polyurethane (PU), where clear light diffusing particles scattered within the resin deflect light rays from the light emitting diodes disposed along the edge of the panel or sheet. The light scattering particles may be selected from any suitable material. For example, the light scattering particle can comprise polystyrene, calcium carbonate, silica, titanium dioxide, acrylic acid, silicone, or polyethylene. In this edge lighting configuration, the total internal reflection is suppressed, allowing light rays to exit the sheet via the surface as indicated in FIG. 62, in a very precise and controlled manner. This effect provides a uniform glowing surface. The mounting plate 6230 is also provided with a reflective inner surface 6215 so that light bounces off this surface in a random pattern and exits downwardly through the plate 6209 to provide a pleasing light pattern. The mounting plate 6230 supports from below a power supply converter, such as the power supply converter 6250, which is mounted to the under surface of the mounting plate 6230 where it is concealed from view. The power supply converter 6250 is electrically coupled to the printed circuit boards 6220 so the individual light emitting diodes disposed thereon may be energized for emitting light energy. In this preferred embodiment, two printed circuit boards have been illustrated where the printed circuit boards face one another. It is contemplated that other printed circuit board arrangement could also be provided in the kit. For example a single board on only one side of the mounting plate, or four boards may be provided for each edge of a sheet or plate, such as sheet 6209 for a luminous ceiling or a wall application. As these various components are substantially similar to those that have been described herein with reference to other kits, the various component mentioned will not be described in greater detail.

Referring to FIG. 63 there is yet another example illustrated in a lighting system 6300 and retrofit kit 6310, which kit and system are constructed in accordance with the present invention. The retrofit kit 6310 generally includes a self contained troffer insert 6312 which may be quickly and easily installed in a gutted troffer T which is suspended by a set of support rods, such as a support rod 6317, extending from a garage or office ceiling C. In this arrangement, the lighting system 6300 distributes light energy in two separate and distinct directions, one toward the ceiling C of the garage, and one downward toward the floor of the garage. To provide this type of lighting distribution, the troffer insert 6312 includes a first set of printed circuit boards 6320 which are mounted to the top side or the viewable side of a mounting plate 6330 to provide a light pattern that is downwardly projected toward the floor of the garage. The troffer insert 6312 further includes a second set of printed circuit boards 6320 which are mounted to the underside or the concealed side of the mounting plate 6330 to provide a light pattern that is upwardly projected toward the ceiling C of the garage. The first set and the second set of printed circuit boards 6320 are energized by a power supply converter 6350 which is support from below by the mounting plate 6330. In this regard, the power supply converter 6350 is mounted to the concealed side of the mounting plate 6330 so that the power supply converter 6350 is concealed from view. As these various components are substantially similar to those that have been described herein with reference to other kits, the various component mentioned will not be described in greater detail.

Referring to FIG. 64 there is another example illustrated in a lighting system 6400 and retrofit kit 6410, which kit and system are constructed in accordance with the present invention. The retrofit kit 6410 generally includes a self contained troffer insert 6412 that is adapted to be mounted within a single lamp troffer (not shown). In this regard, the troffer insert 6412 generally includes a mounting plate 6430 which is adapted to support from below a power supply converter 6450. The mounting plate 6430 is further adapted to support from above a single lamp printed circuit board 6420, that has but a single light emitting diode disposed thereon. The power supply converter 6450 is sized to provide a sufficient source of low voltage power to the single lamp printed circuit board 6420.

As a final example of such modification, there is provided a lighting system 600 which is constructed in a manufacturing facility as opposed to making a field retrofit kit modification. In this regard, consider FIG. 47C in greater detail which illustrate the lighting system 600 which is constructed in accordance with the present invention. The light system 600 generally includes a troffer T having a faceplate, such as face plate 614 for example. The face plate of the troffer T has been prepared to receive thereon kit 610 which generally includes at least two sets of diode strips, individually indicated generally at 620. In order to receive the diode strings 620 thereon, the faceplate 614 is first coated with a nonconductive paint indicated at 630. Overlaying the non conductive paint 630 are two strips of conductive paint, a positive line indicated generally at 660 and a negative line 664. The strips of conductive paint 660 and 664 are coupled to a power supply converter 650, which is substantially similar to the power supply 50 and accordingly, it will not be described hereinafter in greater detail. The individual diodes, such as the diode 620 are then mechanically and electrically secured, to the conductive strips 660 and 664. In this manner, the light emitting diodes in the string 620 are provided with a source of low voltage power so they may be energized to radiate light energy. The lighting system 600 is then ready to be connected to a universal source of high voltage so the power supply 650 may be energized to deliver low voltage to the diode strings 620 in the system. A translucent cover, such as the translucent cover 9TC may be provided and supported by the troffer T for helping to diffuse the light generated by the diode strips. From the foregoing then, those skilled in the art can appreciate that the kits described herein may be utilized for single lamp configurations to those configurations with a plurality of lamps where light energy may be disbursed in one direction, two directions or in a multiple number of directions. Therefore, the descriptions hereinabove are not intended to limit the invention, except as indicated in the claims that follow hereinafter.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e. any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Applicants reserve the right to physically incorporate into this specification any and all materials and information from any such patents, publications, scientific articles, web sites, electronically available information, and other referenced materials or documents to the extent such incorporated materials and information are not inconsistent with the description herein.

The written description portion of this patent includes all claims. Furthermore, all claims, including all original claims as well as all claims from any and all priority documents, are hereby incorporated by reference in their entirety into the written description portion of the specification, and Applicant(s) reserve the right to physically incorporate into the written description or any other portion of the application, any and all such claims. Thus, for example, under no circumstances may the patent be interpreted as allegedly not providing a written description for a claim on the assertion that the precise wording of the claim is not set forth in haec verba in written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. For example, a power supply cover (not shown) may be provided as an aesthetic raceway and protective cover 5960 as best seen in FIG. 59A to protect the power supply 5950A; where the cover is adapted to snap fit by compression into a set of C-clips (not shown) disposed on the mounting surface of the mounting plate 5930A. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and that they are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

It is also to be understood that as used herein and in the appended claims, the singular forms “a,” “an,” and “the” include plural reference unless the context clearly dictates otherwise, the term “X and/or Y” means “X” or “Y” or both “X” and “Y”, and the letter “s” following a noun designates both the plural and singular forms of that noun. In addition, where features or aspects of the invention are described in terms of Markush groups, it is intended and those skilled in the art will recognize, that the invention embraces and is also thereby described in terms of any individual member or subgroup of members of the Markush group.

Other embodiments are within the following claims. For example, rather than having as disclosed a neck-head junction with a replaceable head it is contemplated that a unitary ceramic neck-head configuration could be provided using a reverse Morse taper head-neck to collar interconnection allowing the unitary ceramic neck and head to be attached to a metallic collar have a short metallic neck extending therefrom to enable the reverse Morse taper connection. Therefore, the patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

Therefore, provided herein are a lighting system retrofit kit, a lighting system, a method of assembling a lighting system retrofit kit, and a method of testing a lighting system retrofit kit for immediate field installation thereafter. The retrofit kit may be easily and quickly installed in the field or may be supplied to a manufacturer in a factory setting that has only fixtures and wants to provide complete lighting system in a fast and convenient manner by simply installing the self contained retrofit kits of the present invention. In this regards, as described herein kits may be mounted to a fixture by screws, by adhesive, by snap fit, and even by attachment to a conductive substrate. Based on the foregoing, it should be understood by those skilled in the art that other modifications and implementations will occur to those skilled in the art without departing from the spirit and the scope of the invention as claimed. Accordingly, the description hereinabove is not intended to limit the invention, except as indicated in the claims that follow the parts lists provided below.

### PARTS LIST

1 a fluorescent bulb light fixture
2 a troffer
3 a ballast
4 a bulb
5 a bulb
6 HV service
7 a socket bulb
8 a socket bulb
9RC a raceway cover
9TC a translucent cover
10 a retrofit kit
12 a troffer insert 12
14 an upper wall, troffer face plate
18 a twist clip arrangement
20 a module LED board
30 a mounting plate
32 a cluster group
52 push wire connector system
53 power supply mounting hardware
54 a male connector
56 a female connector
70 a safety mounting clip
72 mounting bracket arrangement
72A a mounting bracket
74 mounting hardware (screw and washer set)
75 a safety chain
76 support snaps
78 wire nuts
80 mounting arrangement
87 wire nuts
100 a lighting system
101 a verify step
102 a fixture cover removal step
104 a lamp removal step
106 a ballast cover removal step
108 a ballast removal step
110 an electrical socket removal step
112 a return step
200 a lighting system
210 a self contained retrofit kit
212 a self contained illumination assembly
220 a modular light emitting diode bard
230 a diode board substrate
250 a power supply converter
300 a lightning system
310 a self contained retrofit kit
310A a self contained retrofit kit
310T a reflow profile table
320 a module LED board
320G a reflow profile graph
330 a printed circuit board substrate
330A a printed circuit board substrate
330D a pad design layout
340T an information table
350T a reliability table
360 a criteria table
370 a flexible tape
371 a reel
372 a feed direction
373 a polarity mark
374 an identification label
380 a power supply mounting hole
380A a mounting plate
381 a power supply mounting hole
390 dimensions criteria
400T a dimension table
400 a lighting system
410 a self contained retrofit kit
412 a self contained troffer
420 a modular LED board
442 current control resister
443 current control resister
444 current control resister
445 current control resister
450 a power supply converter
480 a mounting plate
500 a lighting system
510 a self contained retrofit kit
512 a self contained troffer insert
520 a modular LED printed circuit board
530 a mounting plate
538 a single strip or string of LEDs
550 a power supply converter
570 mounting hardware
600 a lighting system
620 a modular diode board string
630 a mounting plate
638 a set of three strips or strings of LEDs
650 a power supply converter
660 a non conductive paint
662 a strip of conductive paint
730 a mounting plate
738 a set of six strips or strings of LEDs
1400 a method of retrofitting
1412 a start step
1413 a power disconnect step
1414 a gutting step
1416 a temporarily securing step
1418 a connect wires step
1420 a secure step
1422 a conceal step
1424 an apply voltage step
1426 an end step
2000T a specification chart or table for absolute maximum rating characteristics
2100T an optical characteristic curve for electro-optical characteristics
2200T a specification chart or table for chromaticity bin characteristics
2300T a table for bin data used to construct table 2200T
2400T a specification chart or table for spectral distribution of relative intensity
2500T a specification chart or table for forward current vs. forward voltage
2600T a specification chart or table for relative intensity vs. forward current
2700T a specification chart or table relative intensity vs. ambient temperature
2800T a specification chart or table illustrating derating characteristics
2900T a specification chart or table of forward current vs. chromaticity
3000T a specification chart or table for the LED characteristics of radiation
5800 a lighting system
5810 a self contained retrofit kit
5812 a troffer insert
5820 a modular LED printed circuit board
5830 a mounting plate
5840 a power supply mounting bracket
5850 a power supply converter
5900 a lighting system
5910 a self contained retrofit kit
5912 a troffer insert
5920 a modular LED printed circuit board
5930 a mounting plate
5950 a power supply converter
5900A a lighting system
5910A a self contained retrofit kit
5912A a troffer insert
5920A a modular LED printed circuit board
5930A a mounting plate
5950A a power supply converter
6000 a lighting system
6010 a self contained retrofit kit
6012 a troffer insert
6020 a modular LED printed circuit board
6030 a mounting plate
6050 a power supply converter
6100 a lighting system
6110 a self contained retrofit kit
6112 a troffer insert
6115 a reflective surface
6120 a modular LED printed circuit board
6130 a mounting plate
6140 a mounting bracket
6150 a power supply converter
6200 a lighting system
6210 a self contained retrofit kit
6212 a troffer insert
6215 a reflective surface
6220 a modular LED printed circuit board
6230 a mounting plate
6250 a power supply converter
6300 a lighting system
6310 a self contained retrofit kit
6312 a troffer insert
6320 a modular LED printed circuit board
6330 a mounting plate
6350 a power supply converter
6400 a lighting system
6410 a self contained retrofit kit
6412 a troffer insert
6420 a modular LED printed circuit board
6430 a fixture or mounting plate
6450 a power supply converter
A an adhesive
C a ceiling
JTP a jumper board
T a troffer

I claim:

1. A retrofit kit for a fluorescent light fixture coupled to a universal source of electrical power, comprising:
a mounting plate adapted to replace a ballast cover of the fluorescent light fixture after the fixture is disconnected from the universal source of electrical power and gutted of its ballast, electrical sockets and ballast cover;
said mounting plate having mounted thereto:
an electrical conversion device adapted to be coupled to the disconnected universal source of electrical power for transforming said universal source of electrical power to a constant power source; and
a plurality of electrical elements coupled to said constant power source for converting electrical energy into visible radiant energy in substantially the same light pattern generated by the fluorescent light fixture with improved luminance.

2. The retrofit kit according to claim 1, wherein said mounting plate is a flexible mounting plate having sufficient flexibility to be flexed and snap fit into the fluorescent light fixture after gutted of its ballast, electrical sockets and ballast cover.

3. The retrofit kit according to claim 2, wherein said mounting plate is provided with mounting hardware to secure the mounting plate to the fluorescent light fixture after gutted of its ballast, electrical sockets and ballast cover.

4. The retrofit kit according to claim 2, wherein said plurality of electrical elements are connected in series to form at least one elongate string of elements to replicate a single fluorescent bulb with improved luminance.

5. The retrofit kit according to claim 2, wherein said plurality of electrical elements are connected in series to form at least two spaced apart elongate strings of elements to replicate a pair of spaced apart fluorescent bulbs with improved luminance.

6. The retrofit kit according to claim 5, wherein said two spaced apart elongate strings of elements are electrically coupled in series by a jumper mounted to said mounting plate.

7. A retrofit kit for a fluorescent light fixture coupled to a universal source of electrical power, comprising:
a printed circuit board adapted to replace a ballast cover of the fluorescent light fixture after the fixture is disconnected from the universal source of electrical power and gutted of its ballast, electrical sockets and ballast cover;
said printed circuit board having mounted thereto an electrical conversion device adapted to be coupled to the disconnected universal source of electrical power for transforming said universal source of electrical power to a constant power source; and
said printed circuit board further having mounted thereto a plurality of electrical elements coupled to said constant power source for converting electrical energy into visible radiant energy in substantially the same light pattern generated by the fluorescent light fixture with improved luminance.

8. The retrofit kit according to claim 7, wherein said printed circuit board is a flexible printed circuit board having sufficient flexibility to be flexed and snapped fit into the fluorescent light fixture after gutted of its ballast, electrical sockets and ballast cover.

9. The retrofit kit according to claim 7, wherein said printed circuit board is provided with mounting hardware to secure the printed circuit board to the fluorescent light fixture after gutted of its ballast, electrical sockets and ballast cover.

10. The retrofit kit according to claim 7, wherein said plurality of electrical elements are connected in series to form at least one elongate string of elements to replicate a single fluorescent bulb with improved luminance.

11. The retrofit kit according to claim 7, wherein said plurality of electrical elements are connected in series to form at least two spaced apart elongate strings of elements to replicate a pair of spaced apart fluorescent bulbs with improved luminance.

12. The retrofit kit according to claim 11, wherein said two spaced apart elongate strings of elements are electrically coupled in series by a jumper disposed within said printed circuit board.

13. A retrofit kit for a fluorescent light fixture, comprising:
a self contained source of visible radiant energy configured to replicate a light pattern generated by the fluorescent light fixture with improved luminance; and
wherein said self contained source of visible radiant energy is adapted to be coupled to a universal source of electrical energy connected to the fluorescent light fixture and supported by the fluorescent light fixture without modification after the fixture is gutted of its ballast, electrical sockets, and ballast cover.

14. The retrofit kit according to claim 13, wherein said self contained source of visible radiant energy is an electrical conversion device mounted to a flexible mounting plate for transforming the universal source of electrical energy connected to the fluorescent light fixture into a constant current source; and
a plurality of electrical elements coupled to said constant current source for converting electrical energy into visible radiant energy in substantially the same light pattern generated by the fluorescent light fixture with improved luminance.

15. The retrofit kit according to claim 13, wherein said self contained source of visible radiant energy is an electrical conversion device mounted to a flexible mounting plate for transforming the universal source of electrical energy connected to the fluorescent light fixture into a constant voltage source; and
a plurality of electrical elements coupled to said constant voltage source for converting electrical energy into visible radiant energy in substantially the same light pattern generated by the fluorescent light fixture with improved luminance.

16. The retrofit kit according to claim 13, wherein said self contained source of visible radiant energy is an electrical conversion device mounted to a flexible mounting plate for transforming the universal source of electrical energy connected to the fluorescent light fixture into a constant power source; and
a plurality of electrical elements coupled to said power source for converting electrical energy into visible radiant energy in substantially the same light pattern generated by the fluorescent light fixture with improved luminance.

17. The retrofit kit according to claim 16, wherein said plurality of electrical elements are arranged to generate visible radiant energy in X number of substantially straight lines each having a dimension substantially greater in one direction than any in a plane transverse to said one direction.

18. The retrofit kit according to claim 17, wherein X number is one straight line.

19. The retrofit kit according to claim 17, wherein X number is two straight lines.

20. The retrofit kit according to claim 17, wherein X number is three straight lines.

21. The retrofit kit according to claim 17, wherein X number is four straight lines.

22. The retrofit kit according to claim 16, wherein said flexible mounting plate is a flexible printed circuit board.

23. The retrofit kit according to claim 13, wherein the universal source of electrical energy is a 120 volt, 60 Hertz source.

24. The retrofit kit according to claim 13, wherein the universal source of electrical energy is 220 volts to 240 volts at 50 Hz.

25. A light fixture, comprising:
a support unit adapted to be mounted to a stationary surface and for providing access to a universal source of electrical energy; and
a self contained source of visible radiant energy mounted to said support unit and electrically coupled to said universal source of electrical energy for transforming said universal source of electrical energy into visible radiant energy cast in at least one direction to render objects in that direction visible;
wherein said self contained source of visible radiant energy includes:
an electrical conversion device mounted to a substrate for transforming said universal source of electrical energy into a constant current source; and
at least one electrical element coupled to said constant current source for converting electrical energy into visible radiant energy cast in at least one direction to render objects in that direction visible.

26. A light fixture, comprising:
a support unit adapted to be mounted to a stationary surface and for providing access to a universal source of electrical energy; and
a self contained source of visible radiant energy mounted to said support unit and electrically coupled to said universal source of electrical energy for transforming said universal source of electrical energy into visible radiant energy cast in at least one direction to render objects in that direction visible;
wherein said self contained source of visible radiant energy includes:
an electrical conversion device mounted to a flexible substrate for transforming said universal source of electrical energy into a constant voltage source; and
at least one electrical element coupled to said constant voltage source for converting electrical energy into visible radiant energy cast in at least one direction to render objects in that direction visible.

27. A light fixture, comprising:
a self contained source of visible radiant energy mounted to a support unit and electrically coupled to a universal source of electrical energy for transforming said universal source of electrical energy into visible radiant energy cast in at least one direction to render objects in that direction visible;
an electrical conversion device mounted to a flexible mounting plate for transforming said universal source of electrical energy into a constant power source; and
at least one electrical element coupled to said constant power source for converting electrical energy into visible radiant energy cast in at least one direction to render objects in that direction visible.

28. The retrofit kit according to claim 13, wherein said light pattern is a disbursed random array generated by light scattering particles disposed in a sheet of highly transparent resin.

29. The retrofit kit according to claim 1, wherein said plurality of electrical elements are arranged to generate visible radiant energy in X number of substantially straight lines each having a dimension substantially greater in one direction than any in a plane transverse to said one direction.

30. The retrofit kit according to claim 29, wherein X number is one straight line.

31. The retrofit kit according to claim 29, wherein X number is two straight lines.

32. The retrofit kit according to claim 29, wherein X number is three straight lines.

33. The retrofit kit according to claim 29, wherein X number is four straight lines.

34. The retrofit kit according to claim 30, wherein said flexible mounting plate is a flexible substrate.

35. The retrofit kit according to claim 34, wherein said flexible substrate has a cutout area for receiving therein said electrical conversion device; and
wherein said electrical conversion device is mounted within said cutout area by a power supply mounting bracket.

36. The retrofit kit according to claim 34, wherein said electrical conversion device is supported from below by said flexible substrate.

37. The retrofit kit according to claim 34, wherein said electrical conversion device is supported from above by said flexible substrate.

38. The retrofit kit according to claim 37, wherein said plurality of electrical elements are light emitting diode supported from above by said flexible substrate.

39. The retrofit kit according to claim 38, wherein at least some of said light emitting diodes are further supported from below by said flexible substrate to cast light upwardly against a ceiling surface.

40. The retrofit kit according to claim 1, wherein the universal source of electrical energy is 120 volt, at 60 Hertz.

41. The retrofit kit according to claim 1, wherein the universal source of electrical energy is 220 volts to 240 volts at 50 Hz.
